(19) United States
(12) Patent Application Publication
(10) Pub. No.: US 2026/0360389 A1
(43) Pub. Date: Nov. 12, 2026

(54) VIDEO PRODUCING METHOD AND APPARATUS, DEVICE, AND STORAGE MEDIUM

(71) Applicant: Beijing Zitiao Network Technology Co., Ltd., Beijing (CN)

(72) Inventors: Lili FANG, Beijing (CN); Yu MAO, Beijing (CN)

(21) Appl. No.: 19/477,081

(22) PCT Filed: Mar. 25, 2024
(86) PCT No.: PCT/CN2024/083519

§ 371 Date: Oct. 20, 2025

(30) Foreign Application Priority Data
Apr. 21, 2023 (CN) 202310436428.X

(51) Int. Cl. G11B 27/031; G06F 3/0482; G06F 3/04847; G06F 3/16; G11B 27/34

(52) U.S. Cl. CPC G11B 27/031; G06F 3/0482; G06F 3/04847; G06F 3/165; G11B 27/34

(57) ABSTRACT

A method and apparatus for producing a video, a device, and a storage medium are provided in examples of the disclosure. The method includes displaying a video production interface, and the video production interface includes a material function item; displaying a created material group operation region for at least two material groups in a material editing interface presented relative to the material function item, and presenting formed material group information in the created material group operation region; and presenting a pre-generated video list in a video display interface in response to a triggered video display operation; where the video list comprises video information of at least two synthesized videos, video contents comprised in different synthesized videos vary, and the video contents are extracted from materials in each material group respectively.

### CROSS-REFERENCE TO RELATED APPLICATION(S)

The disclosure claims the priority to Chinese Patent Application No. 202310436428. X, filed on Apr. 21, 2023, and entitled “Method and apparatus, device, and storage medium for producing video”, which is incorporated herein by reference in its entirety.

### FIELD

Examples of the disclosure relate to the technical field of video processing, and in particular to a method and apparatus, a device, and a storage medium for producing video.

### BACKGROUND

With increasing popularization of image acquisition devices for shooting and video capturing in work and life, people have a chance to edit or trim originally-shot videos or materials, and create videos richer in content and more attractive to audiences through secondary production (such as splicing of a plurality of re-arranged or re-combined videos and/or pictures). For example, a variety of mashup videos are split after splicing for presenting playback contents.

A current method for producing a video typically requires a professional video producer to continuously edit, splice, and change materials in different forms through professional video production software. Largely relying on manual editing of the producer, this video production process is laborious, and thus has low efficiency and inevitable human errors in video editing. In addition, the current video production software with a video mashup function is complex to operate and high in learning cost.

### SUMMARY

The disclosure provides a method and apparatus, a device, and a storage medium for producing video, to produce a synthesized video simply and effectively.

In a first aspect, a method for producing a video is provided in examples of the disclosure. The method for producing a video includes:
displaying a video production interface for a created video project, where the video production interface includes a material function item and a configuration function item;
displaying a created material group operation region for at least two material groups in a material editing interface presented relative to the material function item, and presenting formed material group information in the created material group operation region;
displaying a configuration operation region for at least two attribute items in an attribute configuration interface presented relative to the configuration function item, and presenting configured attribute configuration information in the configuration operation region; and
presenting a pre-generated video list in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

In a second aspect, an apparatus for producing a video is further provided in the examples of the disclosure. The apparatus for producing a video includes:
a display module configured to display a video production interface for a created video project, where the video production interface includes a material function item and a configuration function item;
a material module configured to display a created material group operation region for at least two material groups in a material editing interface presented relative to the material function item, and present formed material group information in the created material group operation region; and
a video display module configured to present a pre-generated video list in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

In a third aspect, an electronic device is further provided in the examples of the disclosure. The electronic device includes:
one or more processors; and
a storage apparatus configured to store one or more programs; where
the one or more programs cause the one or more processors to perform the method for producing a video in any example of the disclosure when executed by the one or more processors.

In a fourth aspect, a storage medium comprising a computer-executable instruction is further provided in the examples of the disclosure. The computer-executable instruction causes a computer processor to perform the method for producing a video in any example of the disclosure when executed by the computer processor.

According to the technical solutions in the examples of the disclosure, through the method for producing a video provided, the video production interface for the created video project is displayed at first, where the video production interface includes the material function item and the configuration function item. Then, the created material group operation region for at least two material groups is displayed in the material editing interface presented relative to the material function item, and the material group information formed is presented in the created material group operation region, Finally, the pre-generated video list is presented in the video display interface in response to the triggered video display operation. The video list comprises the video information of at least two synthesized videos, the synthesized videos are generated based on the material group information, the video contents comprised in different synthesized videos vary, and the video contents are some or all material contents extracted from the material in each material group respectively.

### BRIEF DESCRIPTION OF THE DRAWINGS

The above and other features, advantages, and aspects in each example of the disclosure will become more apparent with reference to the accompanying drawings and the following particular embodiments. The same or similar reference numerals denote the same or similar elements throughout the accompanying drawings. It should be understood that the accompanying drawings are illustrative, and original devices and elements are not necessarily drawn to scale.

FIG. 1 is a schematic flowchart of a method for producing a video according to an example of the disclosure;

FIG. 1a is an illustrative diagram of displaying a project creation window for an associated video to be produced in a video production interface in the method according to the example;

FIG. 1b is an illustrative diagram of a displayed material editing interface in the method for producing a video according to the example;

FIG. 1c is an illustrative diagram of a presented material group operation region in the material editing interface in the method for producing a video according to the example;

FIG. 1d is an illustrative diagram of presenting material information after material addition in the presented material group operation region;

FIG. 1e is an effect diagram of presenting an attribute configuration control comprised in the presented material group operation region;

FIG. 2a is an illustrative diagram of an attribute configuration interface displayed in the method for producing a video according to the example;

FIG. 2b is an effect diagram of displaying a shot configuration region under the attribute configuration interface in the method for producing a video according to the example;

FIG. 2c is an effect diagram of displaying a sound configuration region under the attribute configuration interface in the method for producing a video according to the example;

FIG. 2d is an illustrative effect diagram of a video display interface in the method for producing a video according to the example;

FIG. 3 is a schematic structural diagram of an apparatus for producing a video according to an example of the disclosure; and

FIG. 4 is a schematic structural diagram of an electronic device according to an example of the disclosure.

### DETAILED DESCRIPTION OF EMBODIMENTS

Examples of the disclosure will be further described in detail below in conjunction with the accompanying drawings. Although some examples of the disclosure are shown in the accompanying drawings, it should be understood that the disclosure can be implemented in various forms and should not be interpreted as being limited to the examples set forth herein. On the contrary, these examples are provided for more thorough and complete understanding of the disclosure. It should be understood that the accompanying drawings and the examples of the disclosure are merely illustrative, and are not intended to limit the scope of protection of the disclosure.

It should be understood that various steps described in a method embodiment of the disclosure can be executed in different orders and/or in parallel. In addition, the method embodiment can include additional steps and/or will not execute the steps shown. The scope of the disclosure is not limited in this respect.

The terms “comprise”, “include”, and their variations used herein indicate open-ended inclusions, i.e. “comprise, but is not limited to” and “include, but is not limited to”. The term “based on” means “at least partially based on”. The term “an example” indicates “at least two examples”. The term “another example” indicates “at least two further examples”. The term “some examples” indicates “at least some examples”. The definitions relevant to other terms are set forth in the description below.

It should be noted that the concepts “first”, “second”, etc. mentioned in the disclosure are merely used to distinguish between different apparatuses, modules, or units, instead of defining an order or interdependence relation of functions executed by these apparatuses, modules, or units.

It should be noted that the modifiers “a”, “an”, and “a plurality of” mentioned in the disclosure are illustrative rather than restrictive. Those skilled in the art should understand that these modifiers should be interpreted as “one or more” unless clearly indicated otherwise in the context.

The name of a message or information interacting between a plurality of apparatuses in the embodiments of the disclosure is merely descriptive, and is not intended to limit the scope of the message or information.

It can be understood that before the technical solutions disclosed in the examples of the disclosure are used, a user should be notified of a type, use scope, use scenario, etc. of personal information involved in the disclosure in an appropriate manner according to relevant laws and regulations, and authorization from the user should be obtained.

For example, in response to receiving an active request from the user, prompt information is transmitted to the user, so as to explicitly prompt the user that a to-be-executed operation requested by the user will require acquisition and use of the personal information of the user. Therefore, according to the prompt information, the user can autonomously select whether to provide the personal information for software or hardware, such as an electronic device, an application, a server, and a storage medium, which executes operations of the technical solutions of the disclosure.

As an optional but non-restrictive embodiment, in response to receiving an active request from the user, prompt information is transmitted to the user through a pop-up window. For example, the prompt information may be presented in the pop-up window in a form of text. In addition, the pop-up window can also carry a selection control for the user to select whether to “agree” or “disagree” to provide the personal information for the electronic device.

It can be understood that the above notification and user authorization acquisition processes are merely illustrative, and do not limit the embodiments of the disclosure. Other methods satisfying the relevant laws and regulations can also be applied to the embodiments of the disclosure.

It can be understood that the data (including, but not limited to, the data itself and acquisition or use of the data) involved in the technical solution should comply with the requirements in corresponding laws and regulations and relevant provisions.

It can be known that at present, when there is an application demand for editing and splicing different materials to form a mashup video with a richer content, it is common practice to perform a manual mashup operation by a professional video producer, or produce a video relying on existing video production software independently. Relying on the professional video producer significantly increases a video production cost. Moreover, a finished video probably is likely to be single and a high production error rate under the limitation of the experience of the video producer. The existing video production software is complex to operate and high in learning cost.

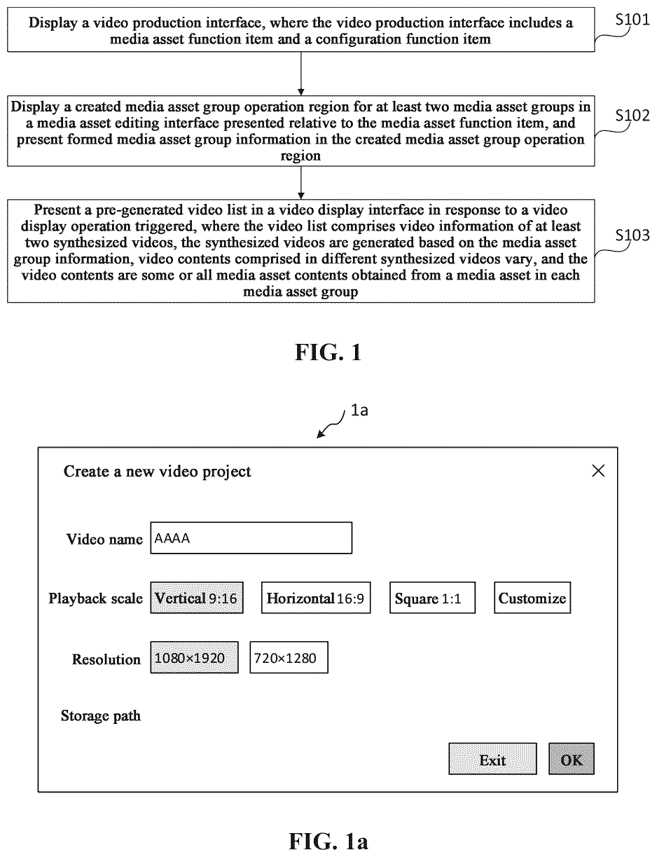

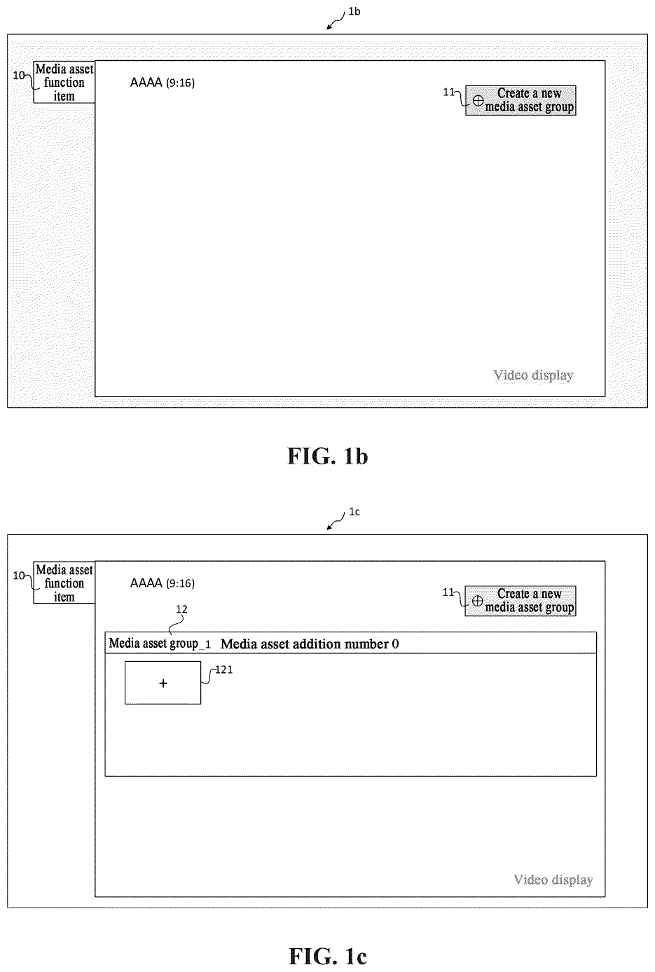

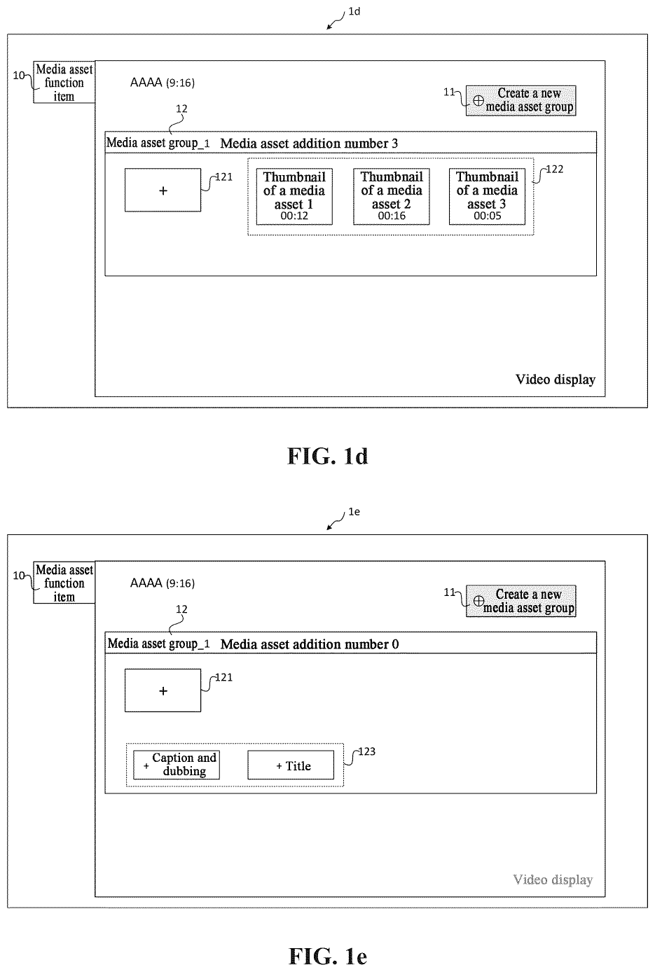

In view of the above, a method for producing a video is provided in the examples of the disclosure. FIG. 1 is a schematic flowchart of a method for producing a video according to an example of the disclosure. The example of the disclosure is applicable to video synthetization of a plurality of material video chips or material images. The method can be performed by an apparatus for producing a video. The apparatus can be implemented in a form of software and/or hardware. Optionally, the apparatus can be implemented by an electronic device that is preferably a mobile terminal, a desktop computer, a laptop computer, a server, etc.

It can be understood that an execution object of the method for producing a video according to the example can be a video production platform with an electronic device as an execution carrier. For example, the video producer can enter the video production platform by triggering an operation entry of the video production platform on the electronic device. Specifically, the video is simply and effectively produced on the video production platform through the method for producing a video according to the example.

As shown in FIG. 1, the method for producing a video according to the example of the disclosure may specifically include:

S101, a video production interface is displayed, and the video production interface includes a material function item and a configuration function item.

In the embodiments, the video production interface displayed corresponds to a video project, and the video project may be deemed as a task instance for performing a task of video production. Before production of a new video is started, one task instance may be created for the video to be produced by triggering a video project creation control, so that the video to be produced may be created in a form of creating a new video project. For creation of the video project, a name of the video project may be edited in a creation window popping up by triggering the video project creation control. Other information related to video production may also be edited. For example, a playback scale of the video produced, a resolution of the video produced, and a storage path of the video produced may be set.

FIG. 1a is an illustrative diagram of displaying a project creation window for an associated video to be produced in a video production interface in the method according to the example. Specifically, after the video project creation control presented on the video production platform is triggered, a project creation window 1a shown in FIG. 1a is presented, and the project creation window la comprises editable items such as a video name, a playback scale, a video resolution, and a storage path of a new created video project. The video to be produced can be named by editing in the above video name editing box. After the video project is created, creation of the task instance corresponding to the video to be produced is completed.

In the step, after a creation operation for the above video project is completed, the video production interface corresponding to the video project may be displayed, and the video production interface includes the material function item and the configuration function item for guiding the video producer to produce the video. The material function item and the configuration function item may be deemed as function modules provided in the video production platform. The material function item may be deemed as providing the video producer with a way to add a material for video production. The configuration function item may be deemed as providing the video producer with a way to configure the material added and different attribute information involved in the video to be produced.

S102, a created material group operation region for at least two material groups is displayed in a material editing interface presented relative to the material function item, and material group information formed is presented in the created material group operation region.

In the embodiment, the material editing interface may be presented relative to the material function item, and may be interpreted as an interface configured to add or create a material required for video production, wherein the material may be a video clip or an image.

Different from importing or selecting all materials required for video production through a material addition control in an existing material addition interface, the concept of material group is introduced into the material editing interface presented in the example. Before the material is added, the video producer may be guided to create at least two material groups, and the materials to be added for video production are grouped through the material groups created, so that materials with different tags or of different types may be added to different material groups.

The materials are added according to the material groups in the example, better matching the production demand of the video producer, ensuring flexibility of material addition, and providing basic support for subsequent effective and diversified video production.

In the step, the formed material group operation region may be displayed after the material groups are created, and one material group operation region may be presented corresponding for each created material group. The material group operation region may be interpreted as an operation region provided for the video producer for adding the material to the material group. A relevant control for guiding the video producer to add the material is presented in the material group operation region. In the example, the material selected or imported in a material addition window may be obtained after a trigger for the relevant control is received, and material group information added is presented by adding material information of the material selected or imported to the material group operation region. In the above case, the material group information may be deemed as the material information of the material added to the corresponding material group. Illustratively, the material information may be a material thumbnail of the material added.

In the embodiment, in addition to the material addition to the material group, the material group operation region may also be configured to implement an operation of a material group associated attribute configuration in the material group. Specifically, in the embodiment, a relevant configuration control for guiding the video producer to perform the material group associated attribute configuration may be presented in the material group operation region. In the embodiment, after a trigger for the relevant configuration control is received, material group associated attribute information edited or configured in an associated attribute configuration window is obtained. Similarly, the material group information added is presented by adding the material group associated attribute information obtained to the material group operation region.

In the above case, in addition to the material information of the added material, the material group operation information may further include the material group associated attribute information configured. Illustratively, the material group associated attribute information may be caption or dubbing information to be presented or title information to be presented when a video clip is formed based on the material added.

It can be understood that the formed material group information in the embodiment needs to include at least the material information of the material added. In addition, a presentation order of the material group operation region and the material group information is not specifically limited in the step, and a specific presentation order may be determined according to a specific video production process. Illustratively, one new material group may be created after one material group is created and a corresponding material is added to the material group. Thus, in the example, after a trigger for creating one material group is received, the corresponding material group operation region may be created and presented. Then, if the video producer directly performs material addition, etc. in the material group operation region, the material group information correspondingly formed may be presented in the material group operation region at first. Finally, a new material group operation region may be presented according to a new trigger operation.

S103, a pre-generated video list is presented in a video display interface in response to a triggered video display operation, wherein the video list comprises video information of at least two synthesized videos, the synthesized videos are generated based on the material group information, video contents comprised in different synthesized videos vary, and the video contents are some or all material contents extracted from a material in each material group.

It should be noted that the demand to be finally satisfied by the video producer in video production can be described as follows: the synthesized videos comprising different video contents can be formed in batches through the materials added, and the video contents are required to be formed by some or all of the material contents of the materials added to different material groups. To form at least two synthesized videos in batches according to the materials in different material groups, it is essential to extract the materials from different material groups, so that each material group corresponds to a plurality of different material chips. Then, different material chips in different material groups can be combined, so that a plurality of synthesized videos comprising different material contents can be formed by different combinations.

After the materials required for video production are added to different material groups and the material group information of different material groups is obtained through the above steps, an execution subject in the example obtains the basic data information for video production equivalently. In the step, after responding to a display operation for the video to be produced, the above material group information obtained is analyzed. Thus, the plurality of synthesized videos is pre-generated based on the materials added by performing feature extraction, material chip division, chipping, and material chip mixing and splicing on the materials added according to the demand to be satisfied by video production. Video information of the plurality of synthesized videos pre-generated is formed into the video list for display in the step.

In the embodiment, it is required to consider some attribute items of the synthesized video to be generated through the video production, for example, a cover of the synthesized video, background music of the synthesized video, a filter of the video contents in the synthesized video, a transition between different material contents in the synthesized video, etc., and for another example, presentation duration of the materials in each material group in the synthesized video, a number of presentation of different material contents in the materials, etc. A pre-generation process of the synthesized video is affected by configuring the above attribute items differently.

In the embodiment, after receiving the triggered video display operation, the execution entity may detect the configuration of each attribute item. If it is determined that no configuration of each attribute item by the video producer is detected, it may be deemed that the video producer has not additionally configured the attribute item of the synthesized video. In this case, the video may be produced with default attribute information preset relative to each attribute item in the example. Illustratively, a default cover determination form, default background music, a default transition form, a default filter, etc. may be taken as attribute information required for pre-generating each synthesized video.

In the embodiment, the material group information of each material group may be obtained after the video producer adds the materials and performs the associated attribute information configuration on each material group on this basis. Then, if it is detected that the video producer does not configure the attribute items involved in generation of the synthesized video, the default attribute information of each attribute item preset may be obtained, so that the synthesized videos are pre-generated in batches in combination with the material group information. The synthesized videos pre-generated may be some or all of the material contents extracted from the materials in each material group, and has the feature that each synthesized video comprises different video contents. Thus, the video contents of the synthesized videos are diversified, and an unglamorous form of the video produced in an existing method for producing a video is solved.

Specifically, an embodiment of a process of pre-generating the synthesized video based on the material group information may be described as follows: the materials added to each material group and material duration of the materials added are determined by the material group information. When the attribute item is not configured, dividing, clipping, splicing, etc. may be performed on the material chips in the materials through the default attribute information. Illustratively, a video production mode corresponding to each material group may be intelligent production by default, and material extraction duration corresponding to the material group may be a fixed length. Accordingly, highlight extraction may be intelligently performed on a plurality of materials added to each material group, and material pictures obtained through highlight extraction may be spliced into a plurality of material chips in the fixed length according to different combination forms. Then, a plurality of material chips corresponding to different material groups may be spliced according to different combination forms. Thus, a plurality of spliced videos formed by the material contents of the materials in the material groups are formed.

On the basis of the above description, in the example, the above spliced videos that have already been preliminary synthesized videos may also be modified through the default attribute information of some global attribute items. For example, a highlighted material picture in the spliced video is taken as the cover of the video, default background music is added, a default transition form is used for a transition between different pictures, and a default filter style is used for filtering the video. In addition, if the material group information comprises the material group associated attribute information, the material chip corresponding to the material group in the spliced video may be modified through the material group associated attribute information. For example, a caption or dubbing is added. Thus, after above processing, the final synthesized video can be pre-generated, and the video information of the synthesized video can be displayed in the video list.

The video information of the synthesized video may include the cover of the video, the highlight material pictures constituting the synthesized video and extracted from each material group, etc., and be presented in a form of a corresponding thumbnail.

With the method for producing a video according to the example, the video producer is provided with a simple and easy-to-operate video production platform equivalently. The video production interface for the video to be produced may be presented on the video production platform, and the material function item configured to add the material may be provided for the video producer in the video production interface. Moreover, the material editing interface may be provided relative to the material function item, so as to guide the video producer to add the materials by group by creating the material groups and adding the material group information to each material group. Finally, the pre-generated video list may be displayed to the video producer only by guiding the video producer to trigger the video display operation in the video production interface. The video list comprises at least two synthesized videos generated based on the material group information and the attribute configuration information. In the above video production process, diversified batch production of the synthesized videos can be implemented only requiring the video producer to simply add the materials required for video production. Thus, a simple and easy-to-operate way to produce the video is provided for the video producer, so that efficiency of the video production is effectively improved and a cost of the video production is reduced while accuracy of the video production is ensured. In addition, a learning cost of the video producer is reduced, and an audience range of the video production is expanded.

As a first optional example of the example, on the basis of the above example, the step that a created material group operation region for at least two material groups is displayed in a material editing interface presented relative to the material function item, and material group information formed is presented in the created material group operation region may be further refined, and the method may specifically include:

a1) The material editing interface is displayed in response to a trigger operation for the material function item, where the material editing interface includes a material group creation control.

In the embodiment, the material function item in the video production interface displayed may be deemed as a triggerable control. The video producer may trigger the material function item when having the demand for material addition for the video production. In the step, the material editing interface may be displayed on a display screen of the electronic device in response to the trigger operation for the material function item. The displayed material editing interface comprises the material group creation control.

Illustratively, FIG. 1b is an illustrative diagram of a material editing interface displayed in the method for producing a video according to the example. As can be seen from FIG. 1b, a material editing interface 1b is displayed relative to a material function item 10, and the material editing interface 1b includes a material group creation control 11 (the control is displayed by creating a new material group).

b1) A new material group is created and a material group operation region for the material group is presented in the material editing interface in response to a trigger operation for the material group creation control, where the material group operation region includes a material addition control.

In the embodiment, the video producer may be guided to add the materials required to different material groups, and materials of different tag types, different categories, or different function types may be added to different material groups. The material groups need to be created at first before the materials are added to different material groups. In the embodiment, the video producer may be guided to initiate creation of the material groups by triggering the material group creation control.

The trigger operation for the material group creation control may be received and response to relevant execution logic may be made in the step. Specifically, one new material group may be created after responding to the triggering operation for the material group creation control. The created material group is presented in the material editing interface in a form of the material group operation region. The presented material group operation region comprises the material addition control for material addition.

Illustratively, FIG. 1c is an illustrative diagram of a presented material group operation region in a material editing interface in the method for producing a video according to the example. As shown in FIG. 1c, the new created material group is presented as a corresponding material group operation region 12 in a material group editing interface 1c in response to a trigger for the material group creation control 11 (for creating the new material group) in the material editing interface 1c. The material group operation region 12 comprises a material addition control 121 for material addition.

c1) At least two materials selected or imported from the presented material addition window are obtained in response to a trigger operation for the material addition control, and the material information of the materials is added and displayed in the corresponding material group operation region as the material group information.

In the embodiment, the video producer may be guided to add the materials involved in the material group in the presented material group operation region. Specifically, the video producer may be guided to trigger the material addition control, so that the material addition window for material addition may pop up. The material addition window may comprise a material collection that can be directly selected, and presents an import box for importing the materials from outside. The video operator may select or import the materials from the material addition window.

At least two materials selected or imported by the video operator from the material addition window may be obtained in the step. The material information of the material obtained from the material group may alternatively be obtained and added and displayed in the material group operation region as the material group information in the step. The material information of the material added may be thumbnail information of the material.

Illustratively, FIG. 1d is an illustrative diagram of presenting material information after material addition in the presented material group operation region. As shown in FIG. 1d, material thumbnails of three materials added are displayed in the material group operation region 12, so as to form material information 122 of the materials added to the corresponding material group. In the embodiment, the material information 122 may be recorded as the material group information of the material group.

According to the above technical solution in the example, through the material function item provided on the video production platform, the video producer can add the materials simply and rapidly, and classified addition of different materials in material addition is implemented on the video production platform, so that clarity and flexibility of the material addition are better ensured.

On the basis of the above first optional example, the example may be further optimized as follows: the presented material group operation region further comprises an attribute configuration control associated with the corresponding material group.

In the optional embodiment, the created material group operation region may not only implement classified addition of the materials, but may also be additionally provided with a function for configuring a material group associated attribute. Specifically, the material group operation region further includes an attribute configuration control. The attribute configuration control additionally provided in the example is equivalent to a configuration entry provided for the video producer for configuring the material group associated attribute.

It should be noted that a number of the attribute configuration control presented in the material group operation region is not limited in the example, and the number of the attribute configuration control may be set according to a number of the material group associated attribute. For example, one attribute configuration control may be presented for each associated attribute to be configured in the material group operation region. The material group associated attribute may be deemed as a playback attribute possessed by the material added to the material group in the synthesized video generated. For example, the associated attribute may be a caption and dubbing attribute possessed by the material in the synthesized video generated, or a title attribute possessed by the material in the synthesized video generated.

As for setting of the attribute configuration control of the material group associated attribute in the material group operation region, its underlying technical support may be deemed as establishing inheritance relations between component codes and component codes corresponding to the associated attributes in a component code corresponding to each created material group respectively, and introducing access entries for the component codes corresponding to the associated attributes in the component code corresponding to the material group. Thus, the video producer may be provided with a trigger entry for an associated attribute configuration by presenting the attribute configuration control in the material group operation region.

FIG. 1e is an effect diagram of presenting an attribute configuration control comprised in the presented material group operation region. As shown in FIG. 1e, the material group operation region 12 further includes an attribute configuration control 123, and a plurality of attribute configuration controls 123 may be provided according to the associated attributes that the material group needs to possess in actual demand. For example, two attribute configuration controls may be presented when two associated attributes are possessed. For example, the two attribute configuration controls 123 presented in FIG. 1e may be a caption and dubbing control and a title control respectively.

On the basis of the above optimization, in the example, after the attribute configuration control is provided for the video producer in the material group operation region, a response operation after the attribute configuration control is triggered may be executed. Specifically, before the material group information is added and displayed in the corresponding material group operation region, the following steps may be further performed in the embodiment:
material group associated attribute information edited in an associated attribute configuration window presented is obtained and taken as the material group information in response to a trigger operation for the attribute configuration control; where
the material group associated attribute information includes caption and dubbing description information and/or title description information corresponding to the material, used during video synthetization, in the material group.

In the optional embodiment, the video producer may trigger the attribute configuration control presented. In the example, in response to the trigger operation for the attribute configuration control, one associated attribute configuration window may be presented relative to the attribute configuration control. The associated attribute configuration window comprises an item to be configured for configuring the associated attribute. In the example, the video producer may be guided to configure the item to be configured in the associated attribute configuration window. The performable configuration includes editing attribute-relevant information, selecting a relevant demand option, etc.

In the embodiment, the material group associated attribute information edited or selected in the associated attribute configuration window may be obtained, and the associated attribute information may alternatively be added and displayed as the material group information. It should be known that when the material group operation region comprises a plurality of attribute configuration controls, it may be deemed that different attribute configuration controls correspond to different material group associated attributes. Thus, when different attribute configuration controls are triggered, the associated attribute configuration windows corresponding to the associated attributes involved may pop up. The associated attribute configuration information obtained from different associated attribute configuration windows may be presented at display positions of the corresponding attribute configuration controls.

Illustratively, when the material group associated attributes are caption and dubbing, and title text respectively, after the caption and dubbing control and a title text control are presented correspondingly, if the attribute configuration control for the caption and dubbing is triggered, the associated attribute configuration information obtained may be the caption and dubbing configuration description information, and if the attribute configuration control for the title text is triggered, the associated attribute configuration information obtained may be the title description information.

According to the above technical solution in the example, the attribute configuration controls for configuring the material group associated attributes are further provided in the material group operation region for material addition. According to the video production platform served by the method for producing a video according to the example, a way to configure the attributes of different material groups is additionally provided equivalently. Thus, the operation is simple and convenient, the corresponding attribute information is more targeted, and the video is further effectively produced. Different from an existing centralized attribute configuration (such as caption addition or title addition) for an entire synthesized video to be generated, according to the above technical solution in the example, the playback attribute corresponding to the material chip in each material group during playback can be independently configured (for example, a caption and a title of the material chip in each material group can be independently configured). Thus, flexibility of the video production is further ensured, diversified configuration forms are provided for the video production, and increasing production demand of users is better satisfied.

On the basis of the above example, a second optional example of the example may be further optimized as follows: the video production interface further includes a configuration function item.

In the embodiment, the material addition may be deemed as a basic operation in the video production process. When the video is produced, in addition to acquisition of the materials on which the video production depends, it is also required to provide some configuration function items allowing the video producer to configure data or information to satisfy the production demand. In addition to additional provision of the attribute configuration item for the material group in the material group operation region mentioned in the above embodiment.

In the second optional example, the configuration function item for a global configuration of video production may be additionally provided in the video production interface. Through the configuration function item provided on the video production platform, the demand for performing personalized production on the video to be produced of the video producer can be satisfied, and alternatively, the video to be produced can implemented the production effect desired by the video producer by a configuration in the configuration function item.

In the second optional example, the following logic may be executed in the example by the configuration function item provided in the video production interface. Specifically, on the basis of the above example, the method according to the example may further include: a configuration operation region for at least two attribute items is displayed in an attribute configuration interface presented relative to the configuration function item, and configured attribute configuration information is presented in the configuration operation region.

Correspondingly, the synthesized video is generated based on the material group information and the attribute configuration information, and the attribute configuration information is configured to define a playback attribute of the synthesized video and selection of the material contents constituting the video contents in the synthesized video.

In the embodiment, the attribute configuration interface may be specifically interpreted as an interface for configuring the relevant attribute for the video production. The relevant attribute for the video production may be an attribute for globally configuring the video to be synthesized, such as the cover, background music, transition, and filter, or an attribute for specifically configuring each material group formed in a material addition stage, such as the playback duration of the video synthesized from the material in each material group, an extraction form for extracting the material from the material group, and sound control when the video synthesized with the material in the material group is played back.

In the embodiment, the attribute configuration interface presented may display the configuration operation region for at least two attribute items required in the video production process, and the configuration operation region comprises the item to be configured allowing the video producer to configure the corresponding attribute item. Illustratively, the item to be configured that is comprised in the configuration operation region where the attribute item is the cover may be a switch control indicating whether to display the cover. When the switch control is in an on state, the presented item to be configured may further include a configuration mode selection control indicating a cover configuration mode.

In the step, configuration information generated after the items to be configured are edited or configured by the video producer in the corresponding configuration operation regions for different attribute items may be obtained, and the configuration information obtained may be presented in the corresponding configuration operation regions as the attribute configuration information of the attribute items.

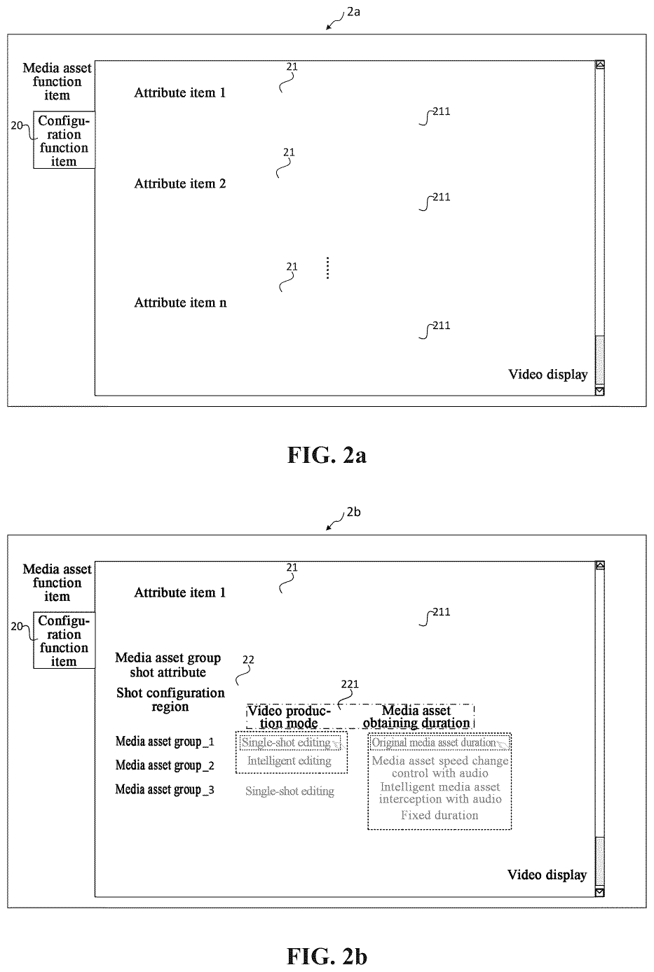

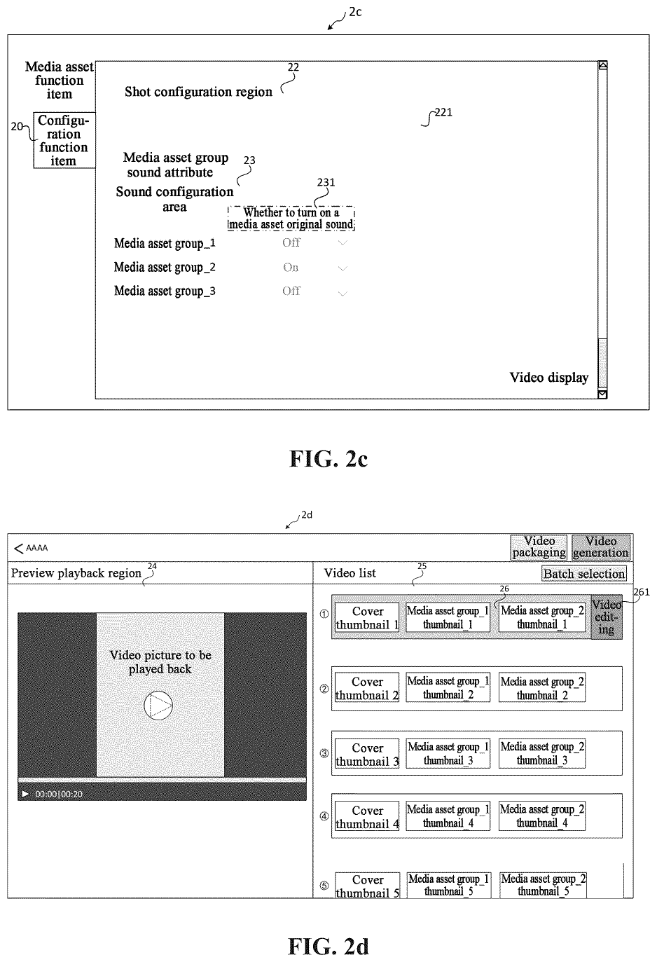

FIG. 2a is an illustrative example of an attribute configuration interface displayed in the method for producing a video according to the example. As can be seen from FIG. 2a, an attribute configuration interface 2a is displayed relative to a configuration function item 20, and the attribute configuration interface 2a includes configuration operation regions 21 corresponding to at least two attribute items. The configuration operation regions 21 corresponding to different attribute items may comprise items 211 to be configured required for configuring the attribute items.

It should be noted that when the video producer has the demand for a configuration operation, an execution order of the material function item and the configuration function item is not specifically limited in the example. The operations in the interfaces corresponding to the two function items may be performed alternatively or repeatedly. Illustratively, after one material group is created and the corresponding material group information is determined in S102 each time, the relevant logic for the configuration function item may be executed based on the steps according to the optional example. Then, the process may be skipped to S102 to re-execute the relevant logic for the material addition. Alternatively, after all the material groups are created and the corresponding material group information is determined in S102 at first, the relevant logic for the attribute item configuration may be entered based on the steps according to the optional example. The execution logic in the optional example may be entered to determine the attribute configuration information after the process is skipped only once.

In the example, after the operation for determining the new attribute configuration information added in the example is executed, for the video production, in addition to the material group information, the influence of the attribute configuration information on the synthesized video also takes a role. Thus, it can be deemed that each synthesized video generated in the video list is generated based on the material group information and the attribute configuration information. The attribute configuration information obtained may be specifically configured to define a playback attribute of the synthesized video and selection of the material contents constituting the video contents in the synthesized video.

Different from the above generation of the synthesized video based on the material group information, for generation of the synthesized video based on the material group information and the attribute configuration information, in the optional example, default configuration information used without an attribute configuration is replaced by the configured attribute configuration information. By deciding a playback effect to be generated or the video contents to be comprised in the synthesized video relying on the attribute configuration information, the video produced can better match the production demand.

According to the above technical solution in the second optional example, the video production platform further provides the configuration function item for configuring the video to be produced for the video producer, allowing the video producer to simply and rapidly edit and configure the attribute information involved in the video to be produced. Different from the prior art that requires experienced producers to perform personalized trimming and splicing with more time, according to the technical solution in the example, a way to implement a rapid personalized configuration is provided for the video to be produced. Thus, a simple configuration operation method provided for the video producer lowers a learning cost of the video production to a greater extent.

On the basis of the above second optional embodiment, the embodiment may be further optimized and defined as follows:
the attribute item comprises one or more of a cover attribute, a playback background attribute, a background music attribute, a filter attribute, a transition attribute, a material group shot attribute, and a material group sound attribute;
the configuration operation region displayed in the attribute configuration interface comprises one or more of a cover configuration region, a playback background configuration region, a background music configuration region, a filter configuration region, a transition configuration region, a shot configuration region, and a sound configuration region, and the shot configuration region and the sound configuration region present an item to be configured in a form of corresponding to each material group.

The attribute configuration information includes one or more of cover configuration information, playback background configuration information, background music configuration information, filter configuration information, transition configuration information, shot configuration information, and sound configuration information.

It can be known that for the video production, in addition to the materials required for the video production, it is also required to consider the effect presented by the video to be produced or a playback effect to be achieved, and video information (such as the cover) for explaining the video to be comprised in the video to be produced, in addition to the video itself. Thus, in the embodiment, the configuration function item configured to configure the video to be produced is provided in the video production.

The attribute item to be configured in the configuration function item may be set in terms of explanation of the video generated, a video playback effect provided, etc. In the example, the attribute item set may preferably include one or more of a cover attribute, a playback background attribute, a background music attribute, a filter attribute, a transition attribute, a material group shot attribute, and a material group sound attribute. The cover attribute may be deemed as a configurable attribute configured to explain the video produced. The background music attribute, filter attribute, and transition attribute may be deemed as configurable attributes required for enhancing the playback effect of the video to be formed. The material group shot attribute may be deemed as a configurable attribute required for dividing, extracting, or splicing the materials in the video production process. The material group sound attribute may be deemed as a configurable attribute required for enhancing playback effects of the materials from different material groups in the video produced.

In the example, different configuration operation regions may be presented in the attribute configuration interface relative to different attribute items. Illustratively, the configuration operation region may comprise a cover configuration region, a playback background configuration region, a background music configuration region, a filter configuration region, a transition configuration region, a shot configuration region, and a sound configuration region corresponding to different attribute items described above. It should be noted that the material group shot attribute in the attribute item is configured corresponding to each material group. Thus, the item to be configured that is comprised in the shot configuration region presented relative to the material group shot attribute is presented in a form of corresponding to each material group.

In the embodiment, after the corresponding configuration operation regions for different attribute items are provided for the video producer in the attribute configuration interface, corresponding attribute configuration information of different attribute items may be obtained. Preferably, the attribute configuration information may include one or more of cover configuration information, playback background configuration information, background music configuration information, filter configuration information, transition configuration information, shot configuration information, and sound configuration information.

According to the above technical solution in the example, relevant information such as the attribute items is specifically optimized, configuration item information that are configurable in the video production is further clarified, and a simplified way is provided for the video production.

On the basis of the above second optional example, the cover configuration region, the playback background configuration region, the background music configuration region, the filter configuration region, and the transition configuration region may be recorded as global configuration regions, and the global configuration region may specifically comprise a configuration switch control.

In the embodiment, different attribute items may be distinguished and divided according to different effects or actions exerted by the attribute items in the video production. For example, the cover attribute, the playback background attribute, the background music attribute, the filter attribute, and the transition attribute may be deemed as global configuration items for controlling the playback effect that can be presented by the synthesized video in the video production. Thus, the cover configuration region, the playback background configuration region, the background music configuration region, the filter configuration region, and the transition configuration region corresponding to the above attribute items may be recorded as the global configuration regions.

In the embodiment, the item to be configured that is comprised in the configuration operation region recorded as the global configuration region is mainly one configuration switch control.

As an embodiment, in response to the configuration operation region is the global configuration region, before the step that configured attribute configuration information being presented in the configuration operation region, in the second optional example, the method may be further optimized to include:

a2) Attribute configuration information of the attribute item corresponding to the global configuration region is determined as being empty in response to detecting that the configuration switch control in the global configuration region is in an off state.

In the embodiment, the corresponding attribute configuration information of the attribute item may be obtained before the attribute configuration information is presented in the interface. In the step, during acquisition of the attribute configuration information, if it is detected that the configuration switch control comprised in the configuration operation region serving as the global configuration region is in the off state, it may be deemed that the video producer has not performed the configuration operation on the corresponding attribute item, or it may be deemed that the video producer has closed previous configuration information for the global configuration region. In this case, the attribute configuration information of the attribute item corresponding to the global configuration region may be determined as being empty. In other words, the attribute configuration information does not participate in generation of the synthesized video, and the default configuration information of the corresponding attribute item may be used if necessary during the generation of the synthesized video.

b2) A configuration mode option is presented in the global configuration region in response to detecting that the configuration switch control is in an on state, and the configuration mode option includes a customized configuration, an intelligent configuration, and a fixed configuration.

In the embodiment, if it is detected that the configuration switch control is in the on state in the step, it may be deemed that the video producer has activated the configuration operation for the attribute items corresponding to these global configuration regions. In this case, the configuration mode option configured for the attribute configuration may be presented in the global configuration region. In the method for producing a video in the example, the video production platform on which the method for producing a video depends may provide three configuration mode options in the global configuration region, and the three configuration mode options may specifically include the customized configuration, the intelligent configuration, and the fixed configuration.

The customized configuration provides a way to edit the item to be configured in a customized manner for the video producer equivalently. In an intelligent configuration mode, it may be deemed that the video producer hands the configuration right to the video production platform, and the video production platform intelligently matches appropriate attribute data during execution of the method for producing a video. In a fixed configuration mode, it may be deemed that the video production platform provides some options for the video producer to select appropriate attribute data therefrom.

c2) At least one configuration content selected or edited from a customized editing window presented is taken as the attribute configuration information of the corresponding attribute item in response to receiving a trigger operation for the customized configuration.

In the embodiment, the step may be deemed as execution logic generated after the customized configuration in the above configuration mode option is triggered. Specifically, the customized editing window may be provided for the video producer, so that the video producer may select or edit at least one configuration content from the customized editing window presented as the attribute configuration information of the corresponding attribute item.

Illustratively, assuming that the global configuration region is the background music configuration region, the customized editing window may comprise a plurality of background music materials. The video producer may select one or more of the plurality of background music materials as the background music configuration information of the background music attribute item. Similarly, an external import box may alternatively be provided in the customized editing window, allowing the video producer to import one or more external materials as background music from a third party. Similarly, the one or more external materials may be taken as the background music configuration information of the background music attribute item.

d2) A configuration content determined based on a policy is taken as the attribute configuration information of the corresponding attribute item in response to receiving a trigger operation for the intelligent configuration.

In the embodiment, the step may be deemed as execution logic generated after the intelligent configuration in the above configuration mode option is triggered. After the video producer triggers the configuration mode option, it may be deemed that the video producer wants to select an appropriate configuration content for the attribute item through an intelligent match policy in the method for producing a video. Thus, the configuration content determined based on the policy may be taken as the attribute configuration information of the corresponding attribute item in response to triggering the mode.

Illustratively, assuming that the global configuration region is the cover configuration region, after the video producer selects the intelligent configuration mode in the cover configuration region, it may be deemed that the video producer wants to select the cover (the configuration content) through an intelligent cover match policy in the method for producing a video.

e2) A configuration content selected from a presented fixed selection box is taken as the attribute configuration information of the corresponding attribute item in response to receiving a trigger operation for the fixed configuration.

In the embodiment, the step may be deemed as execution logic generated after the intelligent configuration in the above configuration mode option is triggered. In practical application, either the fixed configuration mode option or intelligent match is generally set in the global configuration region. After the video producer triggers the fixed configuration, the fixed selection box may be presented in the global configuration region in the step, allowing the video producer to select information to be taken as the configuration content from the fixed selection box. Thus, the configuration content selected may be taken as the attribute configuration information of the corresponding attribute item.

Illustratively, assuming that the global configuration region is the playback background configuration region, after the video producer triggers the fixed configuration in the playback background configuration region, it may be considered that the video producer wants to select a playback background from fixed colors provided by the platform. Thus, a fixed color selected may be taken as the playback background attribute information of the playback background attribute.

It should be noted that in the configuration of the above attribute item in the example, if the attribute configuration information obtained of the corresponding attribute item includes a plurality of configuration contents, during the pre-generation of the synthesized video, one of the plurality of configuration contents may be selected randomly to configure the corresponding attribute item. Different configuration contents may be selected randomly for configuring different synthesized videos.

An implementation of configuring the attribute configuration information in the global configuration region is provided according to the above technical solution in the example. The simple configuration operation method provided for the video producer also lowers the learning cost of the video production to a greater extent.

On the basis of the above second optional example, the example may be further optimized as follows: the item to be configured presented in the shot configuration region in the form of corresponding to each material group includes a video production mode setting item and a material extraction duration setting item.

In the embodiment, the shot configuration region is a type of configuration operation region. When the item to be configured is presented in the shot configuration region in the form of corresponding to each material group, the optional example may be optimized as follows: the item to be configured includes a setting item required for a video production configuration of the material in the material group, where the setting item may include the video production mode setting item and the material extraction duration setting item. The video production mode setting item may be specifically interpreted as an editing form used when the material contents in the material group participate in the video production, and may be single-shot editing or intelligent editing.

In the example, single-shot editing may be interpreted as that the material in the material group is used only once. Thus, a maximum synthesizable material number generated from the material group equals a number of the material added to the material group. Intelligent editing may be interpreted as that one material in the material group may be sub-divided into a plurality of small material chips. Thus, a maximum synthesizable material number generated from the material group may be greater than the number of the material added.

In the example, the material extraction duration setting item may be specifically interpreted as setting of the playback duration occupied by the material in the material group in the synthesized video. Illustratively, the material extraction duration setting item may include original material duration, material speed change control with audio, intelligent material interception with audio, and fixed duration.

The original material duration may be interpreted as that the original material duration used in the video production is taken as the playback duration occupied by the material in the material group in the synthesized video generated. The material speed change control with audio may be interpreted as that the playback duration occupied by the material in the material group in the synthesized video generated is relevant to a playback speed of material audio. The intelligent material interception with audio may be interpreted as that the playback duration occupied by the material in the material group in the synthesized video generated is relevant to playback duration of the audio. In this case, the synthesized video may comprise only some material contents of the material in the material group. The fixed duration may be interpreted as that only a fixed value is preset for ensuring the playback duration occupied by the material in the material group in the synthesized video generated.

As another implementation, in response to the configuration operation region being the shot configuration region, before the step that configured attribute configuration information is presented in the configuration operation region, in the second optional example, the method may be further optimized to include:

a3) Production mode information selected from a mode setting drop-down list presented is obtained in response to receiving a trigger operation for the video production mode setting item.

In the example, the video producer may be guided to take the shot configuration region as the configuration operation region to be configured currently. Thus, a trigger for the video production mode setting item in the item to be configured that is comprised in the shot configuration region may be received in the step. Considering that the items to be configured in the shot configuration region correspond one-to-one to the material groups created, it can be known that the items to be configured of different material groups are mainly triggered in the shot configuration region.

Specifically, in the step, in response to receiving a trigger operation for a video production mode setting item corresponding to one material group, production mode information relative to the material group may be obtained. The production mode information may be selected by the video producer from the mode setting drop-down list presented.

Illustratively, FIG. 2b is an effect diagram of displaying a shot configuration region under an attribute configuration interface in the method for producing a video according to the example. As shown in FIG. 2b, a shot configuration region 22 comprised in an attribute configuration interface 2b comprises corresponding items 221 to be configured relative to three material groups created respectively. In the step, the item 221 to be configured may be the video production mode setting item. After the item 221 to be configured of one material group is triggered, the mode setting drop-down list may be presented to display two pieces of selectable production mode information of single-shot editing and intelligent editing.

b3) Duration information selected from a duration setting drop-down list presented is obtained in response to receiving a trigger operation for the material extraction duration setting item.

Similarly, in the embodiment, after the material extraction duration setting item in the item to be configured that is comprised in the shot configuration region is triggered in the step, duration information configured for the corresponding material group under the material extraction duration setting item is also obtained in the step. The production mode information may be selected by the video producer from the duration setting drop-down list presented. Moreover, when the fixed duration is selected, a fixed time value edited or selected may be obtained.

Similarly, as shown in FIG. 2b, in the step, the item 211 to be configured may be the material extraction duration setting item. After the item 211 to be configured of one material group is triggered, the duration setting drop-down list may be presented. The duration setting drop-down list may include options of original material duration, material speed change control with audio, intelligent material interception with audio, and fixed duration. It should also be noted that after the fixed duration is selected, an editing box may be displayed at a presentation position of the item 211 to be configured in the example, to select or edit the fixed time value.

c3) The production mode information and/or the duration information are/is taken as the shot configuration information of the associated material group relative to the shot configuration item.

In the step, the production mode information and/or the duration information that are/is obtained above may be taken as the shot configuration information of the corresponding shot configuration item of the material group associated with the item to be configured in the shot configuration region.

A specific implementation description in response to the configuration operation region being the shot configuration region is provided according to the above technical solution in the example. According to the technical implementation, a simple operation way to perform the production configuration in the video production is provided, reducing the learning cost of the video production while efficiency of the video production is ensured.

On the basis of the above second optional example, the example may be further optimized as follows: the item to be configured that is presented in the sound configuration region in a form of corresponding to the material group includes a material original sound switch control.

In the example, in addition to the shot configuration region, there is also a configuration operation region for presenting the item to be configured in a form of corresponding to each material group. The configuration operation region may be a sound configuration region. The optional example may be optimized as follows: the item to be configured in the sound configuration region includes a configuration control configured to configure a sound of the material in the material group in the video production, and may specifically include the material original sound switch control.

As yet another implementation, in response to the configuration operation region being the sound configuration region, before the step that configured attribute configuration information is presented in the configuration operation region is executed, in the second optional example, the method may be further optimized to include:

a4) Turning off a material original sound is determined as attribute configuration information of the associated material group relative to the sound configuration item in response to detecting that the material original sound switch control is in an off state.

In the example, if it is detected that the material original sound switch control in the sound configuration region relative to one material group is in the off state in the step, it may be deemed that the video producer has performed an operation of turning off playback of material original sound audio in the synthesized video. Thus, in the step, turning off the material original sound may be taken as the attribute configuration information of the material group relative to the sound configuration item.

b4) Retaining a material original sound is determined as sound configuration information of the associated material group relative to the sound configuration item in response to detecting that the material original sound switch control is in an on state.

In the embodiment, if it is detected that the material original sound switch control in the sound configuration region relative to one material group is in the on state in the step, it may be deemed that the video producer wants to retain material original sound audio in the synthesized video, and thus activates an operation of turning on the material original sound control. Thus, in the step, retaining the material original sound may be taken as the attribute configuration information of the material group relative to the sound configuration item.

Illustratively, FIG. 2c is an effect diagram of displaying a sound configuration region under an attribute configuration interface in the method for producing a video according to the example. As shown in FIG. 2c, a sound configuration region 23 included in the attribute configuration interface 2c comprises material original sound switch controls 231 corresponding to three material groups created respectively. The material original sound switch controls 231 may be in an on state or an off state.

A specific implementation description in response to the configuration operation region being the sound configuration region is provided according to the above technical solution in the example. Similarly, a simple operation way to perform the production configuration in the video production is provided according to the technical implementation. Thus, the video to be produced can be simply and rapidly configured, ensuring efficiency of the video production, and reducing the learning cost of the video production.

On the basis of the above example, the embodiment may be optimized as follows:
a number of videos of the synthesized video comprised in the video list is less than or equal to a predetermined maximum video number;
video duration of the synthesized video in the video list is within an estimated duration range predetermined; and
the maximum video number and the estimated duration range are determined through the attribute configuration information corresponding to each material group under the material group shot attribute comprised in the attribute item.

In the embodiment, for the pre-generated video list through the method according to the example, it is preferable that the video duration of the synthesized video comprised in the video list is less than or equal to the predetermined maximum video number. It is also preferable that the video duration of the synthesized video in the video list is within the estimated duration range predetermined. In the example, determination may be made by the attribute configuration information of each material group relative to the attribute item of the material group shot attribute comprised in the given configuration function item.

As an implementation for determining the maximum video number and the estimated duration range, the specific description may be as follows: the attribute configuration information corresponding to each material group under the material group shot attribute is obtained, the production mode information configured relative to the video production mode and the duration information configured relative to the material extraction duration are extracted from the attribute configuration information.

In the embodiment, a number of the materials comprised in each material group and material duration of each material comprised may be obtained. Then, a maximum synthesizable material number corresponding to each material group and playback duration corresponding to the material group may be determined according to the production mode information and the duration information in combination with a preset video production rule. Further, a maximum synthesizable material number of all the material groups during video synthetization and an estimated duration range of the synthesized video may be determined. Estimated playback duration of different synthesized videos may vary, so that the estimated duration range can be formed from minimum estimated playback duration to maximum estimated playback duration.

Illustratively, a process of determining the maximum synthesizable material number corresponding to each material group may be described as follows: assuming that the production mode information is set to single-shot editing, the maximum synthesizable material number corresponding to one material group equals a material number of materials comprised in the material group regardless of how the duration information for the material extraction duration is configured; and assuming that the production mode information is set to intelligent editing, when the duration information is configured to be the original material duration or the material speed change control with audio, the maximum synthesizable material number corresponding to one material group equals a material number of materials comprised in the material group.

On the basis of the above description, when the duration information is configured as the intelligent material interception with audio, the maximum synthesizable material number (may be the sum of a ratio of the duration of each material to the time length) corresponding to the material group may be determined according to the material duration of each material in the material group and an audio time length set relative to the material group; and when the duration information is configured as the fixed duration, the maximum synthesizable material number corresponding to the material group may be determined according to the material duration of each material in the material group and the fixed duration.

After the maximum synthesizable material number of each material group is determined according to the above description, the maximum synthesizable material number of the synthesized video generable in the video production may be a product value of the maximum synthesizable material number each material group.

Similarly, the estimated duration range of the synthesized video may be determined through the maximum playback duration and the minimum playback duration corresponding to each material group. A process of determining the maximum playback duration and the minimum playback duration of each material group may be described as follows: when the duration information is configured as the original material duration, the maximum playback duration of one material group is maximum material duration of the materials comprised in the material group, and the minimum playback duration of one material group is minimum material duration of the materials comprised in the material group; when the duration information is configured as the material speed change control with audio or the intelligent material interception with audio, the maximum playback duration and the minimum playback duration of one material group are identical to each other, and both are audio duration of audio configured for the material group; and when the duration information is configured as the fixed duration, the maximum playback duration and the minimum playback duration of one material group are identical to each other, and both are the fixed duration configured.

After the maximum playback duration and the minimum playback duration of each material group are determined according to the above description, the sum of the maximum playback duration and the sum of the minimum playback duration may be determined separately. In the example, the estimated duration range of the synthesized video may be from the sum of the minimum playback duration to the sum of the maximum playback duration.

Further, on the basis of the above example, the example may be further optimized as follows:
the attribute configuration interface further includes a production information preview region.

In the example, it can be known that the attribute configuration information of the attribute item included in the attribute configuration interface may affect the synthesized video to be generated in the video production in the aspects of the number of videos of the synthesized video, the playback duration of the synthesized video, etc. In the example, in a process of configuring the relevant attribute configuration information of the attribute item, relevant data information of the synthesized video to be generated may be calculated in real time. A calculation result may be displayed in the production information preview region includes in the attribute configuration interface.

Illustratively, the production information preview region may display at least one of the following data information: a number of material groups of the created material group, a maximum number of videos of the synthesized video generable, an estimated duration range of the synthesized video, and a total material number of the materials added to all the material groups.

According to the above technical solution in the example, the relevant information of the synthesized video in the video list generated is specifically optimized, which better illustrates that the diversified batch production of the synthesized videos without duplication can be implemented through the method in the example.

On the basis of the above example, a third optional example of the example may be further optimized as follows: the video display interface includes a preview playback region and the video list, where video information of at least two synthesized videos comprised in the video list may be displayed in a display order predetermined.

In the embodiment, the video list is displayed in the video display interface, and the video display interface may further include the preview playback region for preview playback of the synthesized video in the video list. In the embodiment, the display order of the synthesized video in the video list may be determined according to a certain ranking rule, and the synthesized video may be displayed in the display order.

Similarly, it can be known that the video information of each synthesized video is specifically displayed in the video list, and the video information may include a cover of the synthesized video, thumbnails of the materials constituting the synthesized video and divided by material group, etc.

On the basis of the above optimization, the method according to the example may be further optimized to include:

a5) The synthesized video corresponding to the video information is imported into the preview playback region as a video to be played back in response to a selection operation for any of the video information in the video list.

In the embodiment, if the video producer previews any synthesized video displayed in the video list, the video information of the synthesized video may be triggered. The video information may be selected as overall information of the synthesized video regardless of the contents comprised. In the step, the synthesized video corresponding to the video information selected is imported into the preview playback region as the video to be played back in response to a selection operation.

b5) Playback of the video to be played back is activated in response to a trigger operation for a playback switch control in the preview playback region.

In the embodiment, on the basis of the above operation, the video operator may trigger the playback switch control in the preview playback region to activate the playback of the video to be played back in response to the trigger operation in the step.

A specific implementation of the preview playback of the synthesized video in the video list is provided according to the above technical solution in the example. The synthesized video can be effectively previewed before rendered formally. An effective preview check way is provided for the video produced.

On the basis of the above third optional example, in the example, a function implementation for performing a post-configuration on the synthesized video pre-generated also exists in the video display interface. Specifically, in the embodiment, after responding to the selection operation for any of the video information in the video list, the method further includes:

c5) A video editing control is displayed in a selection box of the video information.

In the example, after responding to the selection operation by the video producer for one synthesized video in a5), the video information corresponding to the synthesized video may be selected and displayed in a form of the selection box in the step, and the video editing control for the synthesized video may be presented at a position in the selection box displayed in the step.

In the embodiment, the video editing control may be specifically interpreted as an operation control for performing a post-secondary configuration on the synthesized video selected.

Illustratively, FIG. 2d is an illustrative effect diagram of a video display interface in the method for producing a video according to the example. As shown in FIG. 2d, a video display interface 2d includes a preview playback region 24 and a video list 25, and the video list 25 comprises video information of at least two synthesized videos. After one piece of the video information is selected, the synthesized video corresponding to the video information may be imported into the preview playback region 24 as a video to be played back. Moreover, a selection box 26 is displayed on the video information selected, and one video editing control 261 may be presented at a blank position in the selection box.

d5) A video editing region is displayed in the video display interface in response to a trigger operation for the video editing control, and the video editing region comprises at least two video editing items.

In the step, one video editing region may be displayed in the video display interface in response to the trigger operation by the video producer for the video editing control, and the video editing region may comprise at least two video editing items.

In the embodiment, the video editing item may be interpreted as a configurable item for performing the post-secondary configuration on the synthesized video. In the embodiment, the video editing item comprises basically the same attribute items as the configuration function item. Similarly, it may include configurable items such as a cover, background music, a playback background, a transition, and filtering, and may further include configurable items such as text and dubbing, opening, and ending.

e5) An information editing window corresponding to the video editing item is presented in response to a trigger operation for the video editing item.

In the embodiment, the video producer may trigger any video editing item in the video editing region. In response to the trigger operation, the information editing window corresponding to the video editing item may be presented in the step. It can be known that the information editing window is presented in a form of a foldable window, and the information editing window corresponding to the video editing item is presented only after the corresponding information editing window is triggered.

f5) Video editing information edited in the information editing window is obtained and saved in response to a trigger operation for a save control.

In the embodiment, the save control configured to save the editing information is displayed in the information editing window. After the save control is triggered, the video editing information edited by the video producer relative to the synthesized video selected in the information editing window may be obtained, and associated saving of the video editing information may be performed in the step.

It should be noted that the editing information of the synthesized video after post-secondary editing implemented in the above step in the example can be synchronized to the corresponding synthesized video in real time, so that a presentation state of the synthesized video can be adjusted in real time. Illustratively, if the cover of the synthesized video is edited, cover information in the video information presented in the video list relative to the synthesized video will change. For another example, if the background music of the synthesized video is edited, the background music will change when the synthesized video is played back in the preview playback region. For yet another embodiment, after the text and dubbing of the synthesized video are edited, a text and dubbing content played back correspondingly will change when the synthesized video is played back in the preview playback region.

According to the technical solution in the example, a secondary editing function is provided for the video production, and the synthesized video may be re-edited after pre-generated. Thus, a personalized configuration of the synthesized video is implemented, and an entire process is simple and easy to operate, reducing the learning cost of the video producer, and expanding the audience range of the video production.

Secondary editing of the synthesized video in the example is mainly applied to one synthesized video. If several or all synthesized videos are intended to undergo secondary editing, an operation of selecting and triggering the videos in sequence in the above manner is relatively cumbersome.

As a fourth optional example of the example, on the basis of the above third optional example, a method for performing secondary editing in batches is provided. Specifically, the optional example may be optimized as follows: the video display interface includes a video packaging control and a batch selection control presented relative to the video list. Correspondingly, the method according to the example may be further optimized to include:

a6) A selection box for selecting the video information from the video list is displayed, and the video information selected in the selection box is taken as selected video information in response to a trigger operation for the batch selection control.

In the embodiment, the batch selection control may also be set in the video display interface, so as to be triggered when the video producer has the demand for batch selection. In the step, in response to the trigger operation for the batch selection control, a selection box is presented in the display region for the video list relative to the video information of each synthesized video.

On the basis of the above selection box presented, in the example, the video producer may be guided to select the selection box. Moreover, the video information presented after the selection box is selected as the selected video information, and in other words, the synthesized video corresponding to the selected video information is selected.

b6) Current video information to be edited is determined from the selected video information in response to a trigger operation for the video packaging control.

In the embodiment, the video packaging control is also configured to be triggered, to enter secondary editing of the synthesized video. In the example, the video producer may be guided to trigger the video packaging control after performing the selection operation for the selected video information. In the step, in response to a trigger for the video packaging control, each selected video information may be taken as an editable video to undergo secondary editing.

It should be noted that in the example, even if a plurality of pieces of video information to undergo secondary editing are selected, it is still required to perform secondary editing on each piece of the selected video information during actual editing. In the step, one of the plurality of pieces of selected video information may be selected as the current video information to be edited at first. The selection of the current video information to be edited may be determined depending on the display order of the synthesized video in the video list. The display order in the video list may be directly taken as a selection order for selecting the current video information to be edited.

c6) A video editing region presented is associated with the current video information to be edited, so that video editing information of the current video information to be edited is edited in the video editing region.

In the example, after the current video information to be edited is determined in the above step, the video editing region presented after the video packaging control is triggered may be associated with the current information to be edited, so that an operation region for editing the current information to be edited is provided for the video producer.

Same to the video editing region displayed upon triggering when secondary editing is performed on one piece of the video information in the above example, at least two video editing items are also presented in the video editing region. After the video producer triggers one video editing item, an information editing window corresponding to the video editing item may be presented in the video editing region, Thus, video editing information formed after the video producer performs secondary editing on the current video information to be edited in the information editing window may be obtained.

d6) New current video information to be edited is determined from the selected video information, and the process is returned to re-execute c6) in response to receiving a trigger operation for a presented previous selection control or a next selection control.

In the embodiment, a plurality of pieces of selected video information are selected in batches. Thus, editing of next selected video information to undergo secondary editing may be entered by triggering the presented previous selection control or the next selection control in the video display interface. It can be known that an editing order for performing secondary editing of the selected video information is arranged according to the display order of the synthesized video.

After secondary editing of the current information to be edited is completed in the above step, in the step, the current video information to be edited may be re-determined after receiving the trigger operation for the previous selection control or the next selection control. If the previous selection control is triggered, selected video information arranged before the above current video information to be edited in the editing order may be taken as new current video information to be edited. Similarly, if the next selection control is triggered, selected video information arranged after the above current video information to be edited that has undergone secondary editing may be taken as new current video information to be edited.

It should be known that assuming that the current video information to be edited that has undergone secondary editing is first selected video information, the previous selection control needs to be grayed out, and thus cannot be triggered. Similarly, assuming that the current video information to be edited that has undergone secondary editing is last selected video information, the next selection control needs to be grayed out, and thus cannot be triggered.

After the current video information to be edited is re-determined in the step, the process may be returned to c6), so that secondary editing is re-performed on the new current video information to be edited through the execution logic in c6).

In addition, relative to execution of the batch selection, a save control is also displayed in the video display interface. Thus, the video operator may trigger the save control after completing secondary editing of the current video information to be edited, so that the video editing information of the current video information to be edited and the video editing information of other selected video information completed before are saved. The save control may alternatively be triggered after secondary editing of all the selected video information is completed, so that the video editing information of all the selected video information is saved.

According to the above technical solution in the example, a batch secondary editing function of the synthesized videos can be provided for the video production, the plurality of synthesized videos can undergo secondary editing after pre-generated, and the personalized configuration of the synthesized videos can also be implemented. Thus, an entire process is simple and easy to operate, reducing the learning cost of the video producer, and expanding the audience range of the video production.

It should be noted that in the embodiment, the synthesized video pre-generated in the above video production is rendered for video preview equivalently, but does not really undergo backend rendering. By pre-generating the synthesized video in the above rendering mode for video preview, simple and effective preview for the video production can be implemented on the basis of occupying a small number of computation resources. However, since no backend rendering is really performed on the video produced, a video file of the video produced has not been really obtained, and it is impossible to obtain a final target video corresponding to the video produced.

In view of the above, as a fifth optional example of the example, on the basis of the above example, the method according to the example may be further optimized to include:

target videos of the corresponding synthesized videos are generated and saved respectively in response to receiving a generation operation relative to one or more synthesized videos in the video list.

In the example, an operation control for video generation may also be presented in the video display interface, so as to trigger the generation operation for forming the final target video corresponding to the synthesized video in the video list. It should be noted that triggers for the generation operation of the synthesized videos may be performed individually or in batches. When performing in batches is selected, a batch selection state may also be entered by triggering a video batch control, so as to select the synthesized video to generate the final target video, and then the video generation control may be triggered.

In the step, after the generation operation for one or more synthesized videos is received, a backend rendering engine may generate the final target video corresponding to the synthesized video in combination with the video data information of the synthesized video pre-generated in the example, and save the video file of the target video, allowing the video producer or other personnel to download the synthesized video.

According to the technical solution in the embodiment, a final video file generation function of the video produced is provided for the video production, so that an entire production process of the video is completed. The video produced through the above method in the example features batch diversification and content differentiation. Compared with the existing method for producing a video, production efficiency is improved, and effectiveness of the video produced is ensured.

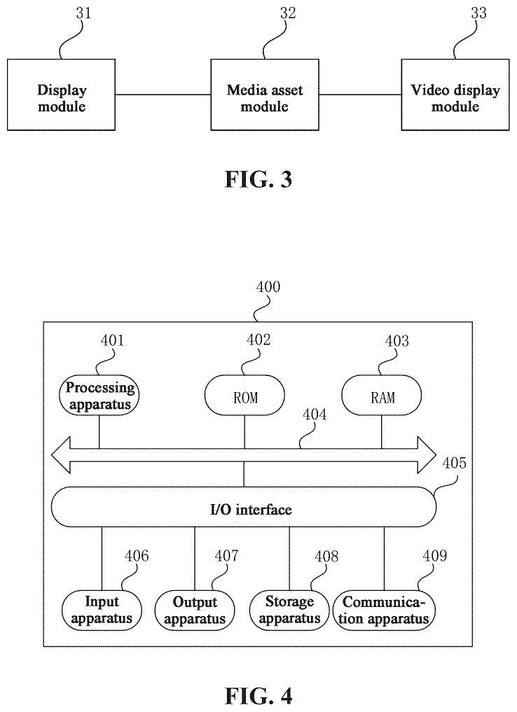

FIG. 3 is a schematic structural diagram of an apparatus for producing a video according to an example of the disclosure. As shown in FIG. 3, the apparatus includes a display module 31, a material module 32, and a video display module 33, where
the display module 31 is configured to display a video production interface for a created video project, where the video production interface includes a material function item and a configuration function item;
the material module 32 is configured to display a created material group operation region for at least two material groups in a material editing interface presented relative to the material function item, and present formed material group information in the created material group operation region; and
the video display module 33 is configured to present a pre-generated video list in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

With the apparatus for producing a video according to the example of the disclosure, a video producer is provided with a simple and easy-to-operate video production platform equivalently. The video production interface for a video to be produced may be presented on the video production platform, and the material function item configured to add the material may be provided for the video producer in the video production interface. Moreover, the material editing interface may be provided relative to the material function item, so as to guide the video producer to add the materials by group by creating the material groups and adding the material group information to each material group. Finally, the pre-generated video list may be displayed to the video producer only by guiding the video producer to trigger the video display operation in the video production interface. The video list comprises at least two synthesized videos generated based on the material group information and the attribute configuration information. In the above video production process, diversified batch production of the synthesized videos can be implemented only requiring the video producer to simply add the materials required for video production. Thus, a simple and easy-to-operate way to produce the video is provided for the video producer, so that efficiency of the video production is effectively improved and a cost of the video production is reduced while accuracy of the video production is ensured. In addition, a learning cost of the video producer is reduced, and an audience range of the video production is expanded.

Further, the material module 32 may be specifically configured to:
display the material editing interface in response to a trigger operation for the material function item, where the material editing interface includes a material group creation control;
create a new material group, and present a material group operation region for the material group in the material editing interface in response to a trigger operation for the material group creation control, where the material group operation region comprises a material addition control;
obtain at least two materials selected or imported from a presented material addition window, and take material information of the materials as the material group information in response to a trigger operation for the material addition control; and
add the material group information, and display the material group information in the corresponding material group operation region.

Further, the presented material group operation region further comprises an attribute configuration control associated with the corresponding material group; and before the material group information is added and displayed in the corresponding material group operation region, the material module may be further configured to:
obtain material group associated attribute information edited in an associated attribute configuration window presented, and take the material group associated attribute information as the material group information in response to a trigger operation for the attribute configuration control; where
the material group associated attribute information includes caption and dubbing description information and/or title description information corresponding to the material, configured for video synthetization, in the material group.

Further, the video production interface further includes the configuration function item. The apparatus further includes a configuration module, and the configuration module is configured to display a configuration operation region for at least two attribute items in an attribute configuration interface presented relative to the configuration function item, and present configured attribute configuration information in the configuration operation region.

Correspondingly, the synthesized video is generated based on the material group information and the attribute configuration information, and the attribute configuration information is configured to define a playback attribute of the synthesized video and selection of the material contents constituting the video contents in the synthesized video.

Further, the attribute item comprises one or more of a cover attribute, a playback background attribute, a background music attribute, a filter attribute, a transition attribute, a material group shot attribute, and a material group sound attribute;
the configuration operation region displayed in the attribute configuration interface comprises one or more of a cover configuration region, a playback background configuration region, a background music configuration region, a filter configuration region, a transition configuration region, a shot configuration region, and a sound configuration region, where the shot configuration region and the sound configuration region present an item to be configured in a form of corresponding to each material group; and
the attribute configuration information includes one or more of cover configuration information, playback background configuration information, background music configuration information, filter configuration information, transition configuration information, shot configuration information, and sound configuration information.

Furthermore, the cover configuration region, the playback background configuration region, the background music configuration region, the filter configuration region, and the transition configuration region are recorded as global configuration regions, and the global configuration region comprises a configuration switch control; and
in response to the configuration operation region being the global configuration region, the apparatus may further include a first configuration editing module, where
before the configuration module executes the step of presenting configured attribute configuration information in the configuration operation region, the first configuration editing module may be configured to:
determine attribute configuration information of the corresponding attribute item to the global configuration region as being empty in response to detecting that the configuration switch control in the global configuration region is in an off state;
present a configuration mode option in the global configuration region in response to detecting that the configuration switch control is in an on state, and the configuration mode option includes a customized configuration, an intelligent configuration, and a fixed configuration;
take at least one configuration content selected or edited from a customized editing window presented as the attribute configuration information of the corresponding attribute item in response to receiving a trigger operation for the customized configuration;
take a configuration content determined based on a policy as the attribute configuration information of the corresponding attribute item in response to receiving a trigger operation for the intelligent configuration; and
take a configuration content selected from a presented fixed selection box as the attribute configuration information of the corresponding attribute item in response to receiving a trigger operation for the fixed configuration.

Furthermore, the item to be configured that is presented in the shot configuration region in the form of corresponding to each material group includes a video production mode setting item and a material extraction duration setting item; and
in response to the configuration operation region is the global configuration region, the apparatus may further include a second configuration editing module, where
before the configuration module executes the step of presenting configured attribute configuration information in the configuration operation region, the second configuration editing module may be configured to:
obtain production mode information selected from a mode setting drop-down list presented in response to receiving a trigger operation for the video production mode setting item;
obtain duration information selected from a duration setting drop-down list presented in response to receiving a trigger operation for the material extraction duration setting item; and take the production mode information and/or the duration information as the shot configuration information of the associated material group relative to the shot configuration item.

Further, the item to be configured presented in the sound configuration region in the form of corresponding to the material group includes a material original sound switch control;
in response to the configuration operation region is the sound configuration region, the apparatus may further include a third configuration editing module, where
before the configuration module executes the step of presenting configured attribute configuration information in the configuration operation region, the third configuration editing module may be configured to:
determine turning off a material original sound as the attribute configuration information of the associated material group relative to a sound configuration item in response to detecting that the material original sound switch control is in an off state; and
determine retaining a material original sound as the sound configuration information of the associated material group relative to the sound configuration item in response to detecting that the material original sound switch control is in an on state.

Further, a number of videos of the synthesized video comprised in the video list is less than or equal to a predetermined maximum video number;
video duration of the synthesized video in the video list is within an estimated duration range predetermined; and
the maximum video number and the estimated duration range are determined through the attribute configuration information corresponding to each material group under the material group shot attribute comprised in the attribute item.

Furthermore, the attribute configuration interface further includes a production information preview region, where
the production information preview region displays at least one of the following data information: a number of material groups of the created material group, a maximum number of videos of the synthesized video generable, an estimated duration range of the synthesized video, and a total material number of materials added to all material groups.

Further, the video display interface includes a preview playback region and the video list, where video information of at least two synthesized videos comprised in the video list are displayed in a display order predetermined.

The apparatus may further include:
a first response module configured to import the synthesized video corresponding to the video information into the preview playback region as a video to be played back in response to a selection operation for any of the video information in the video list; and
a second response module configured to activate playback of the video to be played back in response to a trigger operation for a playback switch control in the preview playback region.

Further, after responding to the selection operation for any of the video information in the video list, the first response module may be further configured to:
display a video editing control in a selection box of the video information;
display a video editing region in the video display interface in response to a trigger operation for the video editing control, where the video editing region comprises at least two video editing items;
present an information editing window corresponding to the video editing item in response to a trigger operation for the video editing item; and
obtain and save video editing information edited in the information editing window in response to a trigger operation for a save control.

Further, the video display interface includes a video packaging control and a batch selection control presented relative to the video list.

The apparatus may further include:
a third response module configured to display a selection box for selecting the video information from the video list, and take the video information selected in the selection box as selected video information in response to a trigger operation for the batch selection control;
a fourth response module configured to determine current video information to be edited from the selected video information in response to a trigger operation for the video packaging control;
an association execution module configured to associate a video editing region presented with the current video information to be edited to edit video editing information for the current video information to be edited in the video editing region; and
a trigger reception module configured to determine new current video information to be edited from the selected video information, and return to re-execute the operation of associating a video editing region presented with the current video information to be edited in response to receiving a trigger operation for a presented previous selection control or a next selection control.

Further, the apparatus may further include:
a video generation module configured to generate and save target videos of the corresponding synthesized videos respectively in response to receiving a generation operation relative to one or more synthesized videos in the video list.

The apparatus for producing a video according to the example of the disclosure can perform the method for producing a video according to any example of the disclosure, has the corresponding function modules for performing the method, and exerts the beneficial effects.

It should be noted that all the units and modules included in the above apparatus are divided merely by function logic, but are not limited to the above division, as long as corresponding functions can be implemented. Also, the specific name of each function unit is merely for ease of differentiation from one another, and is not used to limit the scope of protection in the examples of the disclosure.

FIG. 4 is a schematic structural diagram of an electronic device according to an example of the disclosure. With reference to FIG. 4 below, a schematic structural diagram of an electronic device 400 (for example, a terminal device or a server in FIG. 4) suitable for implementing the example of the disclosure is shown. The terminal device in the example of the disclosure can include, but is not limited to, mobile terminals such as a mobile phone, a notebook computer, a digital broadcast receiver, a personal digital assistant (PDA), a pad, a portable multimedia player (PMP), an in-vehicle terminal (for example, an in-vehicle navigation terminal), and fixed terminals such as a digital television (TV) and a desktop computer. The electronic device shown in FIG. 3 is merely illustrative, and should not limit the functions and use scope in the example of the disclosure in any way.

As shown in FIG. 4, the electronic device 400 can include a processing apparatus 401 (for example, a central processing unit or a graphic processor) that can execute various suitable actions and processing according to a program stored in a read-only memory (ROM) 402 or loaded into a random access memory (RAM) 403 from a storage apparatus 408. The RAM 403 can also store various programs and data required for an operation of the electronic device 400. The processing apparatus 401, the ROM 402, and the RAM 403 are connected to one another through a bus 404. An input/output (I/O) interface 405 is also connected to the bus 404.

Typically, the I/O interface 405 can be connected to the following apparatuses: an input apparatus 406 such as a touch screen, a touch pad, a keyboard, a mouse, a camera, a microphone, an accelerometer, and a gyroscope; an output apparatus 407 such as a liquid crystal display (LCD), a speaker, and a vibrator; a storage apparatus 408 such as a magnetic tape and a hard disk; and a communication apparatus 409. The communication apparatus 409 can allow wireless or wired communication between the electronic device 400 and other devices for data exchange. Although FIG. 4 shows the electronic device 400 having various apparatuses, it should be understood that not all the apparatuses shown are required to be implemented or configured. More or fewer apparatuses can be implemented or configured alternatively.

Particularly, the processes described above with reference to the flowcharts can be implemented as computer software programs according to the example of the disclosure. For example, a computer program product is included in an example of the disclosure. The computer program product includes a computer program carried on a non-transitory computer-readable medium and comprising a program code configured to execute the method shown in the flowchart. In such an example, the computer program can be downloaded and installed over a network through the communication apparatus 409, installed via the storage apparatus 408, or installed via the ROM 402. The computer program executes the above functions defined in the method in the example of the disclosure when executed by the processing apparatus 401.

The name of a message or information interacting between a plurality of apparatuses in the embodiments of the disclosure is merely descriptive, and is not intended to limit the scope of the message or information.

The electronic device according to the example of the disclosure and the method for producing a video according to the above example belong to the same inventive concept, so that reference can be made to the above example for the technical details not described in detail in the example, and the example has the same beneficial effect as the above example.

A computer storage medium is provided in the examples of the disclosure. The computer storage medium stores a computer program, where the computer program implements the method for producing a video according to the above example when executed by a processor.

It should be noted that the above computer-readable medium of the disclosure can be a computer-readable signal medium, a computer-readable storage medium, or any combinations of the above. The computer-readable storage medium can include, but is not limited to, an electronic, magnetic, optical, electromagnetic, infrared, or semiconductor system, apparatus, or device, or any combinations of the above. More specific instances of the computer-readable storage medium can include, but are not limited to, a portable computer magnetic disk, a hard disk, a random access memory (RAM), a read-only memory (ROM), an erasable programmable read-only memory (EPROM) or a flash memory, an optical fiber, a portable compact disk read-only memory (CD-ROM), an optical storage device, and a magnetic storage device that are each electrically connected through one or more wires, or any suitable combinations of the above. In the disclosure, the computer-readable storage medium can be any tangible medium that comprises or stores a program. The program can be used by or in combination with an instruction execution system, apparatus, or device. In the disclosure, however, the computer-readable signal medium can include a data signal propagated in a baseband or as part of a carrier wave, having a computer-readable program code carried thereon. Such a data signal propagated can take various forms including, but not limited to, an electromagnetic signal, an optical signal, or any suitable combinations of the above. The computer-readable signal medium can or be any computer-readable medium except for the computer-readable storage medium. The computer-readable signal medium can transmit, propagate, or transfer a program to be used by or in combination with the instruction execution system, apparatus, or device. The program codes comprised in the computer-readable medium can be transmitted via any suitable medium, including, but not limited to, a wire, an optical cable, a radio frequency (RF), etc., or any suitable combinations of the above.

In some embodiments, clients and servers can communicate with each other via any currently known network protocol (such as a hypertext transfer protocol (HTTP)) or any network protocol to be developed in the future, and can be interconnected to digital data communication (for example, a communication network) in any form or medium. Instances of the communication network include a local area network (LAN), a wide area network (WAN), the Internet, a peer-to-peer network (for example, an ad hoc peer-to-peer network), any currently known network, or any network to be developed in the future.

The above computer-readable medium can be comprised in the above electronic device, or exist alone without being assembled into the electronic device.

The above computer-readable medium carries one or more programs. When executed by the electronic device, the above one or more programs cause the electronic device to display a video production interface for a created video project, where the video production interface includes a material function item and a configuration function item;
display a created material group operation region for at least two material groups in a material editing interface presented relative to the material function item, and present formed material group information in the created material group operation region; and
present a pre-generated video list in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

The computer program codes configured to execute operations of the disclosure can be written in one or more programming languages or their combinations. The above programming languages include, but are not limited to, object-oriented programming languages, such as Java, Smalltalk, and C++, and conventional procedural programming languages, such as “C” language. The program code can be executed on a user's computer in all or in part, executed as an independent software package, executed on a user's computer in part and executed on a remote computer in part, or executed on a remote computer or a server in all. In a case involving the remote computer, the remote computer can be connected to the user's computer through any kind of network, including the local area network (LAN) or the wide area network (WAN), or can be connected to an external computer (for example, through the Internet on the basis of an Internet service provider).

The flowcharts and block diagrams in the accompanying drawings illustrate possibly-implementable system architectures, functions, and operations of the systems, methods, and computer program products according to various examples of the disclosure. In this regard, each block in the flowcharts or the block diagrams can indicate a module, a program segment, or a code segment, which comprises one or more executable instructions configured to implement specified logic functions. It should also be noted that in some alternative implementations, the functions noted in the blocks can also occur in an order other than those noted in the accompanying drawings. For example, two blocks represented in succession can in fact be executed substantially in parallel or in a reverse order sometimes, depending on the functions involved. It should also be noted that each block in the block diagrams and/or the flowcharts and combinations of blocks in the block diagrams and/or the flowcharts can be implemented through specific hardware-based systems that execute the specified functions or operations, or combinations of specific hardware and computer instructions.

The units involved in the examples of the disclosure can be implemented through software or hardware. The name of the unit is not intended to define the unit itself under certain circumstance. For example, a first acquisition unit can also be described as “a unit that obtains at least two Internet protocol addresses”.

At least part of the above functions can be executed by one or more hardware logic components herein. For example, non-restrictively, illustrative types of usable hardware logical components include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium can be a tangible medium that can comprise or store a program to be used by or in combination with the instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combinations of the above. More specific instances of the machine-readable storage media include a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, and a magnetic storage device that are each electrically connected through one or more wires, or any suitable combinations of the above.

According to one or more examples of the disclosure, a method for producing a video is provided in [Example 1]. The method includes:
a video production interface for a created video project is displayed, where the video production interface includes a material function item and a configuration function item;
a created material group operation region for at least two material groups is displayed in a material editing interface presented relative to the material function item, and material group information formed is presented in the created material group operation region; and
a pre-generated video list is presented in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

According to one or more examples of the disclosure, a method for producing a video is provided in [Example 2]. In the method, the step that a created material group operation region for at least two material groups is displayed in a material editing interface presented relative to the material function item, and material group information formed is presented in the created material group operation region includes:
the material editing interface is displayed in response to a trigger operation for the material function item, where the material editing interface includes a material group creation control;
a new material group is created, and a material group operation region for the material group is presented in the material editing interface in response to a trigger operation for the material group creation control, where the material group operation region comprises a material addition control;
at least two materials selected or imported from a presented material addition window are obtained, and material information of the materials is taken as the material group information in response to a trigger operation for the material addition control; and
the material group information is added and displayed in the corresponding material group operation region.

According to one or more examples of the disclosure, a method for producing a video is provided in [Example 3]. The method may be optimized as following: the presented material group operation region further comprises an attribute configuration control associated with the corresponding material group; and before the material group information is added and displayed in the corresponding material group operation region, the method further includes:
material group associated attribute information edited in an associated attribute configuration window presented is obtained, and the material group associated attribute information is taken as the material group information in response to a trigger operation for the attribute configuration control; where
the material group associated attribute information includes caption and dubbing description information and/or title description information corresponding to the material, configured for video synthetization, in the material group.

According to one or more examples of the disclosure, a method for producing a video is provided in [Example 4]. The method includes:
optionally, the video production interface further includes a configuration function item; the method further includes:
a configuration operation region for at least two attribute items is displayed in an attribute configuration interface presented relative to the configuration function item, and configured attribute configuration information is presented in the configuration operation region;
correspondingly, the synthesized video is generated based on the material group information and the attribute configuration information, and the attribute configuration information is configured to define a playback attribute of the synthesized video and selection of the material contents constituting the video contents in the synthesized video.

According to one or more examples of the disclosure, a method for producing a video is provided in [Example 5]. The method includes:
optionally, the attribute item comprises one or more of a cover attribute, a playback background attribute, a background music attribute, a filter attribute, a transition attribute, a material group shot attribute, and a material group sound attribute;
the configuration operation region displayed in the attribute configuration interface comprises one or more of a cover configuration region, a playback background configuration region, a background music configuration region, a filter configuration region, a transition configuration region, a shot configuration region, and a sound configuration region, where the shot configuration region and the sound configuration region present an item to be configured in a form of corresponding to each material group; and
the attribute configuration information includes one or more of cover configuration information, playback background configuration information, background music configuration information, filter configuration information, transition configuration information, shot configuration information, and sound configuration information.

According to one or more examples of the disclosure, a method for producing a video is provided in [Example 6]. Optionally, in the method, the cover configuration region, the playback background configuration region, the background music configuration region, the filter configuration region, and the transition configuration region may also be recorded as global configuration regions, and the global configuration region comprises a configuration switch control; and
in response to the configuration operation region is the global configuration region, before the step that configured attribute configuration information is presented in the configuration operation region is executed, the method may further include:
attribute configuration information of the corresponding attribute item in the global configuration region is determined as being empty in response to detecting that the configuration switch control in the global configuration region is in an off state;
a configuration mode option is presented in the global configuration region in response to detecting that the configuration switch control is in an on state, where the configuration mode option includes a customized configuration, an intelligent configuration, and a fixed configuration;
at least one configuration content selected or edited from a customized editing window presented is taken as the attribute configuration information of the corresponding attribute item in response to receiving a trigger operation for the customized configuration;
a configuration content determined based on a policy is taken as the attribute configuration information of the corresponding attribute item in response to receiving a trigger operation for the intelligent configuration; and
a configuration content selected from a presented fixed selection box is taken as the attribute configuration information of the corresponding attribute item in response to receiving a trigger operation for the fixed configuration.

According to one or more examples of the disclosure, a method for producing a video is provided in [Example 7]. The method may be optimized as follows: the item to be configured that is presented in the shot configuration region in the form of corresponding to each material group includes a video production mode setting item and a material extraction duration setting item; and
optionally, in response to the configuration operation region is the shot configuration region, before the step that configured attribute configuration information is presented in the configuration operation region is executed, the method may further include:
production mode information selected from a mode setting drop-down list presented is obtained in response to receiving a trigger operation for the video production mode setting item;
duration information selected from a duration setting drop-down list presented is obtained in response to receiving a trigger operation for the material extraction duration setting item; and
the production mode information and/or the duration information are/is taken as the shot configuration information of the associated material group relative to the shot configuration item.

According to one or more examples of the disclosure, a method for producing a video is provided in [Example 8]. The method may be optimized as follows: the item to be configured that is presented in the sound configuration region in the form of corresponding to the material group includes a material original sound switch control; and
optionally, in response to the configuration operation region is the sound configuration region, before the step that configured attribute configuration information is presented in the configuration operation region is executed, the method may further include:
turning off a material original sound is determined as the attribute configuration information of the associated material group relative to a sound configuration item in response to detecting that the material original sound switch control is in an off state; and
retaining a material original sound is determined as the sound configuration information of the associated material group relative to the sound configuration item in response to detecting that the material original sound switch control is in an on state.

According to one or more examples of the disclosure, a method for producing a video is provided in [Example 9]. In the method, a number of videos of the synthesized video comprised in the video list is less than or equal to a predetermined maximum video number;
video duration of the synthesized video in the video list is within an estimated duration range predetermined; and
the maximum video number and the estimated duration range are determined through the attribute configuration information corresponding to each material group under the material group shot attribute comprised in the attribute item.

According to one or more examples of the disclosure, a method for producing a video is provided in [Example 10]. In the method, the attribute configuration interface further includes a production information preview region; where
the production information preview region displays at least one of the following data information: a number of material groups of the created material group, a maximum number of videos of the synthesized video generable, an estimated duration range of the synthesized video, and a total material number of materials added to all material groups.

According to one or more examples of the disclosure, a method for producing a video is provided in [Example 11]. The method may be optimized as follows: the video display interface includes a preview playback region and the video list, where video information of at least two synthesized videos comprised in the video list are displayed in a display order predetermined; and
optionally, the method further includes:
the synthesized video corresponding to the video information is imported into the preview playback region as a video to be played back in response to a selection operation for any of the video information in the video list; and
playback of the video to be played back is activated in response to a trigger operation for a playback switch control in the preview playback region.

According to one or more examples of the disclosure, a method for producing a video is provided in [Example 12]. After responding to the selection operation for any one of the video information in the video list, the method further includes:
a video editing control is displayed in a selection box of the video information;
a video editing region is displayed in the video display interface in response to a trigger operation for the video editing control, where the video editing region comprises at least two video editing items;
an information editing window corresponding to the video editing item is presented in response to a trigger operation for the video editing item; and
video editing information edited in the information editing window is obtained and saved in response to a trigger operation for a save control.

According to one or more examples of the disclosure, a method for producing a video is provided in [Example 13]. The method may be optimized as follows: the video display interface includes a video packaging control and a presented batch selection control relative to the video list; and
optionally, the method further includes:
a selection box for selecting the video information in the video list is displayed, and the video information selected in the selection box is taken as selected video information in response to a trigger operation for the batch selection control;
current video information to be edited is determined from the selected video information in response to a trigger operation for the video packaging control;
a video editing region presented is associated with the current video information to be edited, so as to edit video editing information for the current video information to be edited in the video editing region; and
new current video information to be edited is determined from the selected video information, and the process is returned to re-execute the operation that a video editing region presented is associated with the current video information to be edited in response to receiving a trigger operation for a presented previous selection control or a next selection control.

According to one or more examples of the disclosure, a method for producing a video is provided in [Example 14]. The method may further include:
target videos of the corresponding synthesized videos are generated and saved respectively in response to receiving a generation operation relative to one or more synthesized videos in the video list.

According to one or more examples of the disclosure, an apparatus for producing a video is provided in [Example 15]. The apparatus includes:
a display module configured to display a video production interface for a created video project, where the video production interface includes a material function item and a configuration function item;
a material module configured to display a created material group operation region for at least two material groups in a material editing interface presented relative to the material function item, and present formed material group information in the created material group operation region; and
a video display module configured to present a pre-generated video list in a video display interface in response to a triggered video display operation; where
the video list comprises video information of at least two synthesized videos, the synthesized videos are generated based on the material group information, video contents comprised in different synthesized videos vary, and the video contents are some or all material contents extracted from a material in each material group respectively.

What are described above are merely preferred examples of the disclosure and descriptions of the technical principles applied. It should be understood by those skilled in the art that the scope of disclosure involved in the disclosure is not limited to the technical solutions formed by specific combinations of the above technical features, and should also cover other technical solutions formed by random combinations of the above technical features or their equivalents without departing from the concept disclosed above. For example, other technical solutions include those formed through mutual replacement between the above features and the technical features having similar functions disclosed in the disclosure (but not limited thereto).

In addition, all the operations are depicted in a specific order. However, it should not be understood that these operations are required to be executed in the specific order shown or in a successive order. Under certain circumstances, multitasking and parallel processing may be advantageous. Similarly, several specific embodiment details are comprised in the above discussion, but should not be interpreted as limiting the scope of the disclosure. Some features that are described in the context of the separate examples can also be implemented jointly in the single example. Likewise, various features that are described in the context of the single example can also be implemented in a plurality of examples separately or in any suitable sub-combination manner.

Although the subject has been described in a language specific to structural features and/or logical method actions, it should be understood that the subject defined in the appended claims is not necessarily limited to the above specific features or actions. Rather, the above specific features and actions are merely illustrative forms for implementing the claims.

1. A method for producing a video, comprising:
displaying a video production interface, the video production interface comprising a media asset function item;
displaying a created media asset group operation region for at least two media asset groups in a media asset editing interface presented relative to the media asset function item, and presenting formed media asset group information in the created media asset group operation region; and
presenting a pre-generated video list in a video display interface in response to a triggered video display operation; wherein
the video list comprises video information of at least two synthesized videos, the synthesized videos are generated based on the media asset group information, video contents comprised in different synthesized videos vary, and the video contents are some or all media asset contents obtained from a media asset in each media asset group respectively.

2. The method according to claim 1, wherein displaying a created media asset group operation region for at least two media asset groups in a media asset editing interface presented relative to the media asset function item, and presenting formed media asset group information in the created media asset group operation region, comprise:
displaying the media asset editing interface in response to a trigger operation for the media asset function item, the media asset editing interface comprising a media asset group creation control;
creating a new media asset group and presenting a media asset group operation region for the media asset group in the media asset editing interface in response to a trigger operation for the media asset group creation control, the media asset group operation region comprising a media asset addition control;
in response to a trigger operation for the media asset addition control, obtaining at least two media assets selected or imported from a presented media asset addition window and taking media asset information of the media assets as the media asset group information; and
adding the media asset group information, and displaying the media asset group information in the corresponding media asset group operation region.

3. The method according to claim 2, wherein the presented media asset group operation region further comprises an attribute configuration control associated with the corresponding media asset group; and
wherein before adding and displaying the media asset group information in the corresponding media asset group operation region, the method further comprises:
in response to a trigger operation for the attribute configuration control, obtaining media asset group associated attribute information edited in a presented associated attribute configuration window and taking the media asset group associated attribute information as the media asset group information;
the media asset group associated attribute information comprising caption and dubbing description information and/or title description information corresponding to the media asset for video synthetization in the media asset group.

4. The method according to claim 1, wherein the video production interface further comprises a configuration function item, and the method further comprises:
displaying a configuration operation region for at least two attribute items in an attribute configuration interface presented relative to the configuration function item, and presenting configured attribute configuration information in the configuration operation region;
correspondingly, the synthesized video being generated based on the media asset group information and the attribute configuration information, and the attribute configuration information being configured to define a playback attribute of the synthesized video and selection of the media asset contents constituting the video contents in the synthesized video.

5. The method according to claim 4, wherein the attribute item comprises one or more of a cover attribute, a playback background attribute, a background music attribute, a filter attribute, a transition attribute, media asset group shot attribute, and a media asset group sound attribute;
the configuration operation region displayed in the attribute configuration interface comprises one or more of a cover configuration region, a playback background configuration region, a background music configuration region, a filter configuration region, a transition configuration region, a shot configuration region, and a sound configuration region, the shot configuration region and the sound configuration region presenting an item to be configured in a form of corresponding to each media asset group; and
the attribute configuration information comprises one or more of cover configuration information, playback background configuration information, background music configuration information, filter configuration information, transition configuration information, shot configuration information, and sound configuration information.

6. The method according to claim 5, wherein the cover configuration region, the playback background configuration region, the background music configuration region, the filter configuration region, and the transition configuration region are recorded as global configuration regions, and the global configuration region comprises a configuration switch control; and
wherein in response to the configuration operation region being the global configuration region, before performing the step of presenting configured attribute configuration information in the configuration operation region, the method further comprises:
determining attribute configuration information of the corresponding attribute item to the global configuration region as being empty in response to detecting that the configuration switch control in the global configuration region is in an off state;
presenting a configuration mode option in the global configuration region in response to detecting that the configuration switch control is in an on state, the configuration mode option comprising a customized configuration, an intelligent configuration, and a fixed configuration;
taking at least one configuration content selected or edited from a presented customized editing window as the attribute configuration information of the corresponding attribute item in response to receiving a trigger operation for the customized configuration;
taking a configuration content determined based on a policy as the attribute configuration information of the corresponding attribute item in response to receiving a trigger operation for the intelligent configuration; and
taking a configuration content selected from a presented fixed selection box as the attribute configuration information of the corresponding attribute item in response to receiving a trigger operation for the fixed configuration.

7. The method according to claim 5, wherein the item to be configured presented in the shot configuration region in the form of corresponding to each media asset group comprises a video production mode setting item and a media asset obtaining duration setting item; and
in response to the configuration operation region being the shot configuration region, before performing the step of presenting configured attribute configuration information in the configuration operation region, further comprises:
obtaining production mode information selected from a presented mode setting drop-down list in response to receiving a trigger operation for the video production mode setting item;
obtaining duration information selected from a presented duration setting drop-down list in response to receiving a trigger operation for the media asset obtaining duration setting item; and
taking the production mode information and/or the duration information as the shot configuration information of the associated media asset group relative to the shot configuration item.

8. The method according to claim 5, wherein the item to be configured presented in the sound configuration region in the form of corresponding to the media asset group comprises a media asset original sound switch control;
in response to the configuration operation region being the sound configuration region, before performing the step of presenting configured attribute configuration information in the configuration operation region, the method further comprises:
determining turning off a media asset original sound as the attribute configuration information of the associated media asset group relative to a sound configuration item in response to detecting that the media asset original sound switch control is in an off state; and
determining retaining a media asset original sound as the sound configuration information of the associated media asset group relative to the sound configuration item in response to detecting that the media asset original sound switch control is in an on state.

9. The method according to claim 4, wherein
a number of videos of the synthesized video comprised in the video list is less than or equal to a predetermined maximum video number;
video duration of the synthesized video in the video list is within a predetermined estimated duration range; and
the maximum video number and the estimated duration range are determined by the attribute configuration information corresponding to each media asset group under the media asset group shot attribute comprised in the attribute item.

10. The method according to claim 4, wherein the attribute configuration interface further comprises a production information preview region; and
the production information preview region displays at least one of the following data information: a number of media asset groups of the created media asset group, a maximum number of videos of the synthesized video generable, an estimated duration range of the synthesized video, and a total media asset number of media assets added to all media asset groups.

11. The method according to claim 1, wherein the video display interface comprises a preview playback region and the video list,
and the video information of the at least two synthesized videos comprised in the video list is displayed in a predetermined display order; and
wherein the method further comprises:
importing the synthesized video corresponding to the video information into the preview playback region as a video to be played back in response to a selection operation for any of the video information in the video list; and
activating playback of the video to be played back in response to a trigger operation for a playback switch control in the preview playback region.

12. The method according to claim 11, wherein after responding to the selection operation for any of the video information in the video list, the method further comprises:
displaying a video editing control in a selection box of the video information;
displaying a video editing region in the video display interface in response to a trigger operation for the video editing control, the video editing region comprising at least two video editing items;
presenting an information editing window corresponding to the video editing item in response to a trigger operation for the video editing item; and
obtaining and saving video editing information edited in the information editing window in response to a trigger operation for a save control.

13. The method according to claim 11, wherein the video display interface comprises a video packaging control and a batch selection control presented relative to the video list; and
wherein the method further comprises:
in response to a trigger operation for the batch selection control, displaying a selection box for selecting the video information in the video list and taking the video information selected in the selection box as selected video information;
determining current video information to be edited from the selected video information in response to a trigger operation for the video packaging control;
associating a presented video editing region with the current video information to be edited to edit video editing information for the current video information to be edited in the video editing region; and
in response to receiving a trigger operation for a presented previous selection control or a next selection control, determining new current video information to be edited from the selected video information and returning to re-execute the operation of associating a presented video editing region with the current video information to be edited.

14. The method according to claim 1, further comprising:
generating and saving target videos of the corresponding synthesized videos respectively in response to receiving a generation operation relative to one or more synthesized videos in the video list.

15. (canceled)

16. An electronic device, comprising:
one or more processors; and
a storage apparatus configured to store instructions;
when executed by the one or more processors, the instructions cause the one or more processors to
display a video production interface, the video production interface comprising a media asset function item;
display a created media asset group operation region for at least two media asset groups in a media asset editing interface presented relative to the media asset function item, and presenting formed media asset group information in the created media asset group operation region; and
present a pre-generated video list in a video display interface in response to a triggered video display operation; wherein
the video list comprises video information of at least two synthesized videos, the synthesized videos are generated based on the media asset group information, video contents comprised in different synthesized videos vary, and the video contents are some or all media asset contents obtained from a media asset in each media asset group respectively.

17. non-transitory computer-readable storage medium, storing instructions, wherein the instructions, when executed by a processor, cause the processor to:
display a video production interface, the video production interface comprising a media asset function item;
display a created media asset group operation region for at least two media asset groups in a media asset editing interface presented relative to the media asset function item, and presenting formed media asset group information in the created media asset group operation region; and
present a pre-generated video list in a video display interface in response to a triggered video display operation; wherein
the video list comprises video information of at least two synthesized videos, the synthesized videos are generated based on the media asset group information, video contents comprised in different synthesized videos vary, and the video contents are some or all media asset contents obtained from a media asset in each media asset group respectively.

18. The device according to claim 16, wherein instructions causing the processor to display a created media asset group operation region for at least two media asset groups in a media asset editing interface presented relative to the media asset function item and present formed media asset group information in the created media asset group operation region, comprise instructions causing the processor to:
display the media asset editing interface in response to a trigger operation for the media asset function item, the media asset editing interface comprising a media asset group creation control;
create a new media asset group and presenting a media asset group operation region for the media asset group in the media asset editing interface in response to a trigger operation for the media asset group creation control, the media asset group operation region comprising a media asset addition control;
in response to a trigger operation for the media asset addition control, obtain at least two media assets selected or imported from a presented media asset addition window and take media asset information of the media assets as the media asset group information; and
add the media asset group information, and displaying the media asset group information in the corresponding media asset group operation region.

19. The device according to claim 18, wherein the presented media asset group operation region further comprises an attribute configuration control associated with the corresponding media asset group; and
wherein before instructions causing the processor to add and display the media asset group information in the corresponding media asset group operation region, instructions further causing the processor to:
in response to a trigger operation for the attribute configuration control, obtain media asset group associated attribute information edited in a presented associated attribute configuration window and take the media asset group associated attribute information as the media asset group information;
the media asset group associated attribute information comprising caption and dubbing description information and/or title description information corresponding to the media asset for video synthetization in the media asset group.

20. The device according to claim 16, wherein the video production interface further comprises a configuration function item, and instructions causing the processor to:
display a configuration operation region for at least two attribute items in an attribute configuration interface presented relative to the configuration function item, and present configured attribute configuration information in the configuration operation region;
correspondingly, the synthesized video being generated based on the media asset group information and the attribute configuration information, and the attribute configuration information being configured to define a playback attribute of the synthesized video and selection of the media asset contents constituting the video contents in the synthesized video.

21. The device according to claim 20, wherein the attribute item comprises one or more of a cover attribute, a playback background attribute, a background music attribute, a filter attribute, a transition attribute, a media asset group shot attribute, and a media asset group sound attribute;
the configuration operation region displayed in the attribute configuration interface comprises one or more of a cover configuration region, a playback background configuration region, a background music configuration region, a filter configuration region, a transition configuration region, a shot configuration region, and a sound configuration region, the shot configuration region and the sound configuration region presenting an item to be configured in a form of corresponding to each media asset group; and
the attribute configuration information comprises one or more of cover configuration information, playback background configuration information, background music configuration information, filter configuration information, transition configuration information, shot configuration information, and sound configuration information.
